(19) United States
(12) Patent Application Publication
(10) Pub. No.: US 2007/0222922 A1
(43) Pub. Date: Sep. 27, 2007

(54) Graded contrast enhancing layer for use in displays

(75) Inventors: Elaine W. Jin, Webster, NY (US); Fitzroy H. Crosdale, Rochester, NY (US); Scott E. Phillips, Rochester, NY (US); Myron W. Culver, Rochester, NY (US); Donald R. Preuss, Rochester, NY (US); John C. Brewer, Rochester, NY (US)

Correspondence Address: Paul A. Leipold;Patent Legal Staff, Eastman Kokak Company, 343 State Street, Rochester, NY, 14650-2201, US

(73) Assignee: Eastman Kodak Company

(21) Appl. No.: 11/386,992

(22) Filed: Mar. 22, 2006

(51) Int. Cl. G02F 1/1333; G02F 1/1347

(52) U.S. Cl. 349/110; 349/74

(57) ABSTRACT

The present invention relates to a display, and a method for making the display, comprising a substrate, an inactive area comprising at least one conductive layer, an active area comprising an electrically modulated imaging layer comprising an electrically modulated imaging material, and at least one graded contrast enhancing matrix layer wherein the graded contrast enhancing matrix layer comprises a light absorbing material, wherein the graded contrast enhancing matrix layer has a refractive index, wherein the imaginary part of the refractive index increases with distance from the substrate, and the change in the imaginary part of the refractive index through the thickness of the graded contrast enhancing matrix layer is greater than 0.2, wherein the graded contrast enhancing matrix layer registers with at least a portion of the inactive area and extends into said active area.

### FIELD OF THE INVENTION

The present invention relates to light absorbing layers in display devices.

### BACKGROUND OF THE INVENTION

Light absorbing surfaces have been fabricated in a variety of ways, from simple carbon black, to organic dyes in a binder, to thin film absorbing optical stacks. It is usually fairly simple to prevent light from being transmitted by the absorbing surface, so that any light which is not absorbed, will be reflected. The desired property of a light absorbing surface is to minimize the amount of light reflected regardless of the wavelength, the angle, and the polarization of the incoming light.

U.S. Pat. No. 6,829,078 B2 is directed to electrophoretic displays and semi-finished display panels comprising display cells prepared from microcup and top-sealing technologies. The partition walls dividing the display cells may be opaque. The top surface of the partition walls dividing the display cells may also be colored, preferably blackened by a dye or pigment. Alternatively, the top-sealed cells may be covered by a black matrix layer having the black pattern registered to the partition walls. However, the disclosure indicates only specific positions of a black mask and transmission optical density. It does not mention the importance of top and bottom surface reflection and the coverage of the black matrix area.

The term black matrix or shadow mask generally refers to a patterned layer in a display, which is transparent in the active regions, non-reflective as well as opaque in the inactive regions. The black matrix is used to improve the contrast of the display in a lighted environment such as an office or outdoors.

A number of formulations have been used which perform to various levels. A simple chromium metal film has a reflectivity of approximately 50% across the visible spectrum. Graphite dispersions can have a reflectivity as low as a few percent. Organic dyes and pigments can also provide a blackening function.

U.S. Pat. No. 5,808,714 discloses a low reflection shadow mask constructed from multiple layers of a metal and a dielectric. They report formulations with Cr/CrOx, Si/SiOx, Ti/TiOx, and Ta/TaOx. The structure used is a substrate, a partially oxidized metal layer, a thin unoxidized metal layer (approx 10-20 nm), another partially oxided metal layer, and a thick metal layer (approx 100-200 nm), which serves as an opaque layer. In some cases, additional pairs of layers may be added. With this structure, good absorption may be achieved across the visible spectrum, and at various angles of incidence. This approach suffers from the need to sequentially coat dissimilar materials, and to control their thickness. It also involves the coating of an extremely thin metal layer (100-200 Angstroms) which could be vulnerable to subsequent oxidation, and, therefore, a change in thickness or refractive index.

U.S. Patent Publication 2003/0063241 relates to a liquid crystal display panel to be used as a light bulb in a liquid crystal projector or the like, an opposite substrate for the liquid crystal display panel, and a method of fabricating them, and more specifically, relates to a light-shielding film formed on an opposite substrate for a liquid crystal display panel. A graded layer is described, which is a co-mixture of a low reflective (CrOx) and a high reflective (Al) material to avoid thermal stress in the layer.

U.S. Pat. No. 6,387,576 discloses a black matrix which is a black coating layer which surrounds the pixels of a display device, a method for preparing the black matrix, and a display device employing the black matrix. The black matrix may be a graded layer of SiO plus a metal (V, Co Fe, Ti).

U.S. Pat. No. 5,827,409 relates to liquid crystal color displays. In particular, the invention relates to a black matrix for a liquid crystal color display widely used in laptop computers and portable televisions. The method for forming a thin film for a liquid crystal display comprises depositing a metal oxide on a transparent substrate surface by reactive sputtering. The method comprises introducing gaseous argon and gaseous oxygen to a space in front of a cathode provided with a target of the respective metal and depositing a thin film comprising the metal oxide on the substrate by reactive sputtering by operating the cathode while moving the substrate parallel to the front side of the target. The gaseous argon and the gaseous oxygen are introduced so that the partial pressure of the gaseous oxygen is lower at the upstream or the downstream side of the moving direction of the substrate. The gaseous oxygen is diluted with gaseous nitrogen to a predetermined ratio. The thin film comprising the metal oxide is deposited while adjusting the metal concentration gradient of the film. An apparatus for forming a thin film for a liquid crystal display by depositing a metal oxide on a transparent substrate surface by reactive sputtering.

EP 1111438 relates to a black matrix and a method of preparation. The black matrix is a black coating layer surrounding pixels of a display device. It includes SiO which is a dielectric material and at least one metal selected from the group consisting of iron (Fe), cobalt (Co), vanadium (V) and titanium (Ti). The black matrix has excellent thermal and chemical stability and is environmentally desirous by using a mixture of a nontoxic metal and a dielectric material. Also, the black matrix exhibits excellent adhesion to a substrate without an annealing process, is excellent in mechanical characteristic due to the absence of internal stress and is capable of being micro-patterned to have a particle size of 1 μm or less. When applied to the substrate of the display device, the black matrix exhibits excellent external light absorbing effect, thereby improving luminance and contrast characteristics.

U.S. Pat. No. 6,157,426 relates to a liquid crystal display (LCD) including a multilayer black matrix that includes at least one layer of a material that has variable amounts of chemical elements, most preferably at least one layer of silicon oxynitride. The composition of layers can be slowly varied through the thickness of the system so that the refractive index adjacent the substrate substantially matches that of the substrate and so that there are no overly large refractive index differences between adjacent layers in the system. This reduces light reflections off of the black matrix system.

U.S. Pat. No. 6,579,624 relates to a functional film, and more particularly, to a functional film having adjustable optical and electrical properties. The film includes a transition layer having a first constituent having SiO as a dielectric material and at least one second constituent selected from aluminum (Al), silver (Ag), silicon (Si), germanium (Ge), yttrium (Y), zinc (Zn), zirconium (Zr), tungsten (W) and tantalum (Ta). The first and second constituents have corresponding gradual content gradients according to a thickness of the functional film.

U.S. Pat. No. 6,623,862 relates to a functional film, and more particularly, to a functional film having adjustable optical and electrical properties. The film includes a transition layer with a first constituent selected from aluminum and silicon and at least one second constituent selected from oxygen and nitrogen, the first and second constituents having gradual content gradients according to a thickness of the functional film.

U.S. Pat. No. 6,627,322 relates to a functional film, and more particularly, to a functional film having adjustable optical and electrical properties. The film includes a transition layer having a first constituent and a second constituent having gradual content gradients according to a thickness of the functional film. The first constituent is at least one dielectric material selected from the group consisting of SiOx (x>1), MgF₂, CaF₂, Al₂O₃, SnO₂, In₂O₃ and ITO, and the second constituent is at least one material selected from the group consisting of iron (Fe), cobalt (Co), titanium (Ti), vanadium (V), aluminum (Al), silver (Ag), silicon (Si), germanium (Ge), yttrium (Y), zinc (Zn), zirconium (Zr), tungsten (W) and tantalum (Ta).

The present invention avoids the prior art in several ways. First, the present invention utilizes an oxide and a metal where the metal could be opaque, and the oxide transparent or absorbing. The present invention also utilizes a graded contrast enhancing matrix layer with a refractive index with an imaginary portion, which increases with distance from the substrate, and demonstrates a specific change in refractive index through the thickness of the graded layer. The graded layer also registers with the cell wall containing the electrically modulated imaging material and extends into the area covered by the electrically modulated imaging material.

### PROBLEM TO BE SOLVED

There remains a need for materials for use in reflective displays to enhance the luminance contrast and image quality and which simplifies manufacturability by providing a display coated from a single source in a single continuous process. It would also be desirable to have a structure for a black matrix which was more robust with regard to the precise thickness and refractive index of the coated layers.

### SUMMARY OF THE INVENTION

The present invention relates to a display comprising a substrate, an inactive area comprising at least one conductive layer, an active area comprising an electrically modulated imaging layer comprising an electrically modulated imaging material, and at least one graded contrast enhancing matrix layer wherein the graded contrast enhancing matrix layer comprises a light absorbing material, wherein the graded contrast enhancing matrix layer has a refractive index, wherein the imaginary part of the refractive index increases with distance from the substrate, and the change in the imaginary part of the refractive index through the thickness of the graded contrast enhancing matrix layer is greater than 0.2, wherein the graded contrast enhancing matrix layer registers with at least a portion of the inactive area and extends into the active area. The present invention also relates to a specific display comprising, in order, a transparent substrate, a graded contrast enhancing matrix layer matched to the index of refraction of the transparent substrate and becoming gradually more absorbing as one proceeds within the graded contrast enhancing matrix layer away from the transparent substrate, a transparent dielectric fluid layer comprising a dielectric fluid divided into cells by a plurality of spacers, wherein the spacers maintain a gap for containing the dielectric fluid between the transparent substrate and an upper insulating layer, a middle insulating and reflection layer, and a bottom substrate layer, wherein the graded contrast enhancing matrix layer comprises a light absorbing material, wherein the graded contrast enhancing matrix layer has a refractive index, wherein the imaginary part of the refractive index increases with distance from the substrate, and the change in the imaginary part of the refractive index through the thickness of the graded contrast enhancing matrix layer is greater than 0.2, wherein the graded contrast enhancing matrix layer is between the transparent substrate and the transparent dielectric fluid layer, registers with at least a portion of the spacers and extends into at least a portion of the dielectric fluid. The present invention also relates to a method of making a display comprising providing a substrate; applying at least one patterned, graded contrast enhancing matrix layer thereon, wherein the graded contrast enhancing matrix layer comprises a light absorbing material, wherein the graded contrast enhancing matrix layer has a refractive index, wherein the imaginary part of the refractive index increases with distance from the substrate, and the change in the imaginary part of the refractive index through the thickness of the graded contrast enhancing matrix layer is greater than 0.2, wherein the graded contrast enhancing matrix layer registers with at least a portion of the inactive area of the display and extends into the active area of the display; applying an inactive area comprising at least one conductive layer; and applying an active area comprising an electrically modulated imaging layer comprising an electrically modulated imaging material.

### ADVANTAGEOUS EFFECT OF THE INVENTION

The present invention includes several advantages, not all of which are incorporated in a single embodiment. The use of the present inventive matrix layer produces a display which is easier to manufacture than conventional displays and has enhanced luminance contrast and image quality.

### BRIEF DESCRIPTION OF THE DRAWINGS

FIG. 1 is a cross-sectional view of a graded contrast enhancing matrix layer structure of the invention.

FIG. 2 is a graph of the Angle Averaged Reflectivity (AAR) for a contrast enhancing matrix layer, here, a black matrix layer, with a fixed index absorber of n=1.8, and various values for k.

FIG. 3 is a graph showing the correlation between AAR and Reduced Absorption Integral (RAI), computed for a variety of values for refractive index and layer thickness.

FIG. 4 is a plot of AAR as a function of wavelength for a graded contrast enhancing matrix layer, here, a black matrix layer, computed in Example 3a (Black Matrix with CrOx (Linear k Graded) Absorber).

FIG. 5 is a plot of AAR as a function of wavelength for a graded contrast enhancing matrix layer, here, a black matrix layer, with a Reduced Index Gradient (RIG) computed in Example 3b (Black Matrix with CrOx (gradual n) graded absorber)

FIG. 6 shows an electrophoretic display 3×3 cell array.

FIG. 7a illustrates an electrophoretic display device in a dark state, which uses in-plane switching.

FIG. 7b illustrates an electrophoretic display device in a light state, which uses in-plane switching.

FIG. 8 illustrates the coverage of a black matrix disclosed in prior art (U.S. Pat. No. 6,829,078).

FIG. 9 shows the graded contrast enhancing matrix layer, here, a black matrix layer, coverage in which the graded contrast enhancing matrix layer covers the top of the cell partition wall and the top of the collecting electrode.

FIG. 10 shows the graded contrast enhancing matrix layer, here, a black matrix layer, coverage in which the graded contrast enhancing matrix layer covers the top of the cell partition wall, the top of the collecting electrode, and the gaps.

FIG. 11 shows the results of optical simulation of the dark state of an electro-optic display using three coverage options for the black matrix.

FIG. 12 shows the luminance contrast level as a function of the viewing angle for three graded contrast enhancing black matrix layer coverages.

FIG. 13 shows the optical modeling simulation results of the study described in Example 7.

FIG. 14 illustrates a sequence of steps for patterning the black matrix.

FIG. 15 illustrates the total reflectance of the coated sample of Example 1.

FIG. 16 illustrates the total transmittance of the coated sample of Example 1.

FIG. 17 illustrates a display according to the present invention comprising stacked elements with contrast enhancing matrix layer.

FIG. 18 shows a simplified electrophoretic cell structure utilized in Example 7.

### DETAILED DESCRIPTION OF THE INVENTION

The present invention relates to at least one graded contrast enhancing matrix layer disposed on a substrate, a display utilizing these layers and a method of making the graded contrast enhancing matrix layer. The graded contrast enhancing matrix layer comprises a light absorbing material. The graded contrast enhancing matrix layer has a refractive index, of which, the imaginary part increases with distance from the substrate, and the change in the imaginary part of the refractive index through the thickness of the graded contrast enhancing matrix layer is greater than 0.2.

In a preferred embodiment, a black graded contrast enhancing matrix layer is used to mask inactive areas on reflective display devices to enhance the luminance contrast and image quality. The first aspect of this invention specifies the optical aims for creating an ideal graded contrast enhancing matrix layer. The optical aims include the reflection aim for the top surface (the first surface from the view direction), the transmission aim for the whole black matrix structure, and the reflection aim for the bottom surface (the last surface from the view direction). Another aspect of the graded contrast enhancing matrix layer creation is the coverage area. The graded contrast enhancing matrix layer is preferably patterned, hence, its ability to mask and the importance of coverage. The patterning results in the ability to locate the graded contrast enhancing matrix layer were it is needed and does not limit the application of the contrast enhancing matrix layer to any display structure, for example, a cell wall. The graded contrast enhancing matrix layer can be applied so as to cover portions of both the active and inactive areas of the display. In this invention the matrix coverage area, preferably a dark or black color, is defined as a function of the useful angular viewing zone. The angular luminance contrast of the display device is shown to be significantly impacted by the matrix coverage area.

The present invention relates to a graded contrast enhancing matrix layer. In one embodiment, the functional layer may be a color contrast layer. Contrast enhancing matrix layers may be radiation reflective layers or radiation absorbing layers. The contrast enhancing matrix is preferably dark, and can most preferably be black. The contrast enhancing matrix layer may also be other colors. The dark contrast enhancing matrix layer can comprise milled nonconductive pigments. The materials are milled below 1 micron to form “nano-pigments”. In a preferred embodiment, the dark contrast enhancing matrix layer absorbs all wavelengths of light across the visible light spectrum, that is, from 380 nanometers to 780 nanometers wavelength. The dark contrast enhancing matrix layer may also contain a set or multiple pigment dispersions. Suitable pigments used in the color contrast layer may be any colored materials, which are practically insoluble in the medium in which they are incorporated. Suitable pigments include those described in Industrial Organic Pigments: Production, Properties, Applications by W. Herbst and K. Hunger, 1993, Wiley Publishers. These include, but are not limited to, Azo Pigments such as monoazo yellow and orange, diazo, naphthol, naphthol reds, azo lakes, benzimidazolone, diazo condensation, metal complex, isoindolinone and isoindolinic, polycyclic pigments such as phthalocyanine, quinacridone, perylene, perinone, diketopyrrolo-pyrrole, and thioindigo, and anthriquinone pigments such as anthrapyrimidine.

The objective of a graded contrast enhancing matrix layer, preferably, a black matrix layer, is to create a planar structure which receives incident light, and reflects none of it, either specularly or diffusely. An absolute black matrix cannot be fabricated from real materials, so it is necessary to formulate a figure of merit to evaluate the performance of a particular black matrix. The figure of merit proposed is a compromise of ease of measurement (or calculation) with relevance to the desired black matrix properties. The quantity which will be used is the Angle Averaged Reflectivity, AAR of the matrix, where

$$AAR = \frac{{\sum }_{p} \int {\int }_{Ω} {\int }_{λ} R ( θ , λ , p ) ⅆ λ ⅆ Ω}{{\sum }_{p} \int {\int }_{Ω} {\int }_{λ} ⅆ λ ⅆ Ω} .$$

The function R(θ,λ,p) is the reflectivity function for the surface, which is a function of the incident angle θ, the wavelength λ, and the polarization p, of the incident light.

The AAR is obtained by averaging R over all wavelengths of interest, over all solid angles of interest, and over all polarizations of interest. In the present work, unless otherwise stated, wavelengths will generally span the visible spectrum (380 nm to 780 nm). Solid angles of interest will generally be the cone of sub-critical angles in the substrate material relative to vacuum, and both transverse electric (TE) and transverse magnetic (TM) polarizations will be equally included. Light entering the substrate from the air will refract according to Snell's law to an angle below the critical angle in the substrate. Optical constants were obtained from Palik. (Edward D. Palik, Handbook of Optical Constants of Solids, Academic Press Inc., (1985) and Edward D. Palik, Handbook of Optical Constants of Solids II, Academic Press Inc., (1991) and references therein, hereafter referred to as “Palik”).

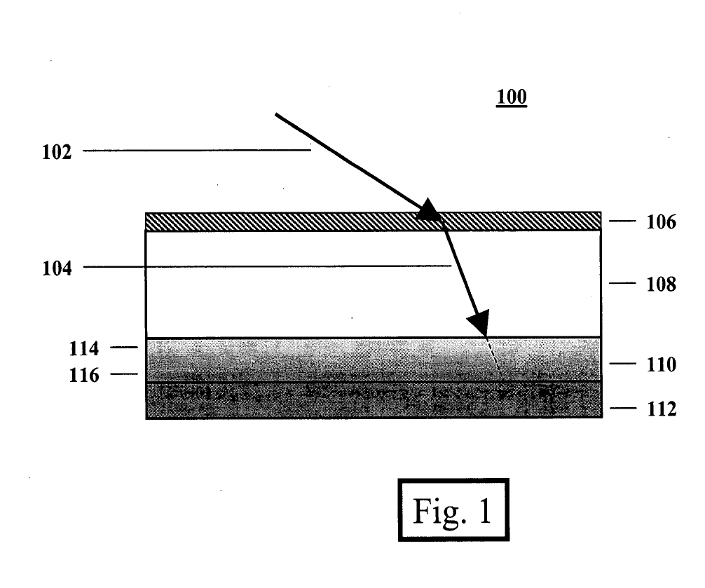

The general structure of the proposed graded contrast enhancing matrix layer, here, a black matrix layer, is shown in FIG. 1. It consists of two, optionally three, basic components. The first component is a transparent substrate 108, such as glass or plastic, which may be flexible or conformable, and is predominantly transmissive in some part of the spectrum of interest. The substrate is assumed to be thick compared to the wavelength of light, so that the phase of the light which has propagated through the substrate is not controlled, and any interaction with light which has not passed through the substrate is incoherent. The second, component is a graded contrast enhancing matrix layer, most preferably in the form of a graded absorber 110, which, to some extent, matches the index of refraction of the transparent substrate 108, and then becomes gradually more absorbing as one proceeds within the graded absorber layer (contrast enhancing matrix layer), away from the transparent substrate. The optional third component is an opaque layer 112. The opaque layer 112 may be omitted if the graded absorber (contrast enhancing matrix layer) is sufficiently opaque, or if the intended use of the black matrix is tolerant to transmitted light. Often, the black matrix may meet the non-reflective requirement, but has an unacceptable transmission in some region of the spectrum. The opaque layer can then be included to correct this shortfall. The opaque layer can be a metallic film, but is not limited to metallic materials. An antireflection coating 106 may be applied to the air side of the substrate in order to minimize reflections at the substrate-air interface. It is also possible that the side of the substrate opposite the side of the contrast enhancing matrix layer may be in contact with a medium other than air.

For ease of fabrication, graded absorber 110 (contrast enhancing matrix layer) may be a fully oxidized metal at the boundary with transparent substrate 108, and gradually decrease in level of oxidation until there is little oxidant at the boundary with opaque layer 112. Opaque layer 112 is then the same metal that is used to form the graded absorber (contrast enhancing matrix layer). The combination of graded absorber 110 (contrast enhancing matrix layer) and opaque layer 112 could be fabricated by a single vacuum sputtering step in which a metal target is at first sputtered in an oxidant plus Argon gas mixture, and then the oxidant is gradually decreased through the sputtering process until the sputtered material is fully metallic. The preferred metal for this structure is chromium, and the preferred oxidant is oxygen, but other metals and oxidants can be used to fabricate a graded contrast enhancing matrix layer structure.

It is desired that the AAR be less than 5%, and preferably be less than 2%, and most preferably, be less than 0.5%. Constraints must be placed on the layers of the black matrix in order to achieve this level of performance. First, it is necessary to minimize reflections at the interface between transparent substrate 108 and the transparent side 114 of graded absorber (contrast enhancing matrix layer). This can be achieved by minimizing the strength of the interface by requiring that the discontinuity in n and k for transparent substrate and the transparent side of the graded absorber (contrast enhancing matrix layer), be kept low. Optical modeling shows that a reliable metric is the distance in the complex plane of the refractive index of the transparent substrate and transparent side of the graded absorber (contrast enhancing matrix layer). To this end, the Interfacial Index Discontinuity (IID) will be defined as:
IID=\sqrt{(n₂−n₁)²+(k₂−k₁)²}

Where n₁ and k₁ are the real and imaginary parts of the refractive index of one material at the interface, and n₂ and k₂ are the real and imaginary parts of the refractive index of the other material at the interface. Using standard optical modeling of coherent layered structures, based on the Fresnel equations, one finds that in order to keep the AAR for just this interface below 3% requires that IID<0.60. In order to keep the AAR for just this interface below 1% requires that IID<0.35. In order to keep the AAR below 0.5%, IID<0.25.

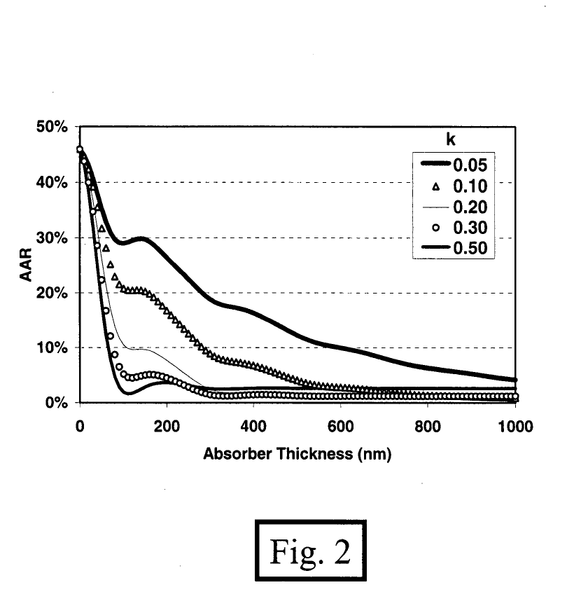

Referring to FIG. 2, it was assumed that the absorber has a fixed index with n=1.8, and various values of k from 0.05 to 0.50. The transparent substrate was assumed to have a refractive index of n=1.6, similar to polyethylene terephthalate, and an opaque layer of 100 nm of chromium metal. The AAR was calculated as a function of absorber thickness, for all angles less than 40 degrees (inside the substrate), and for wavelengths from 380 nm to 780 nm. At the lowest value for k (0.05), reflection from the substrate-absorber interface was minimal, but even with 1000 nm of thickness, reflectivity was still over 4%. At high k (0.50), only 100 nm of absorber was needed to obtain the best performance of 1%, but this was a result of thickness tuning. At other larger thickness values of the absorber, the AAR was as high as 3%. Although this fixed composition absorber may seem like a reasonable solution for lower performing contrast enhancing matrix layers, it will be very difficult to implement when working with real absorber materials which are dispersive (the refractive index is a function of the wavelength) because one must then select a single thickness which will simultaneously optimize performance for both high and low values of k. Use of a graded absorber layer (contrast enhancing matrix layer) eliminates this problem. By selecting a low value of k for the graded absorber (contrast enhancing matrix layer) at the interface with the transparent substrate, the reflection off of this interface is minimized. Then, by allowing the graded absorber (contrast enhancing matrix layer) to gradually become more absorbing (k increases) as the coating progresses, one can obtain a high optical density for a relatively thin absorber. In fact, the optical density is relatively insensitive to the thickness of the graded absorber (contrast enhancing matrix layer).

The thinnest structure for the graded contrast enhancing layer preferably has the imaginary part of the refractive index increase monotonically with distance from the substrate. Variations from a monotonic increase may occur without destroying the function of the layer, but are, in general, detrimental. The benefits of grading the layer are minimal if the change in the imaginary part of the refractive index is less than 0.2. Preferably, the change in the imaginary part of the refractive index through the thickness of the graded contrast enhancing matrix layer is greater than 0.5, and, most preferably, greater than 1.0. A desirable a contrast enhancing matrix layer, most preferably, a black matrix layer, must have a low AAR, as well as a minimal thickness to reduce cost and improve the ability to pattern the layer. An AAR value of less than 5% across the visible spectrum is considered acceptable, but values of less than 2%, or even 0.5% are achievable. A dimensionless metric, which reliably predicts this requirement, is the Reduced Absorption Integral (RAI) defined here as:

$$RAI ( λ ) = \frac{{\int }_{0}^{T} k ( t ) * ⅆ t}{λ}$$

Where T is the thickness of the graded absorber (contrast enhancing matrix layer), k(t) is the imaginary part of the complex refractive index of the graded absorber (contrast enhancing matrix layer) at a distance t from the interface with the near dielectric layer, for light of vacuum wavelength λ. For a film layer which varies linearly with k, this definition simplifies to

$$RAI ( λ ) = \frac{( {k}_{ 1} + {k}_{ 2} ) T}{ 2 λ}$$

where k₁ and k₂ are the imaginary parts of the refractive index of the graded absorber (contrast enhancing matrix layer) at the start and finish of the layer. In the event of a graded absorber (contrast enhancing matrix layer), which is not linear in k, this formula is only approximate.

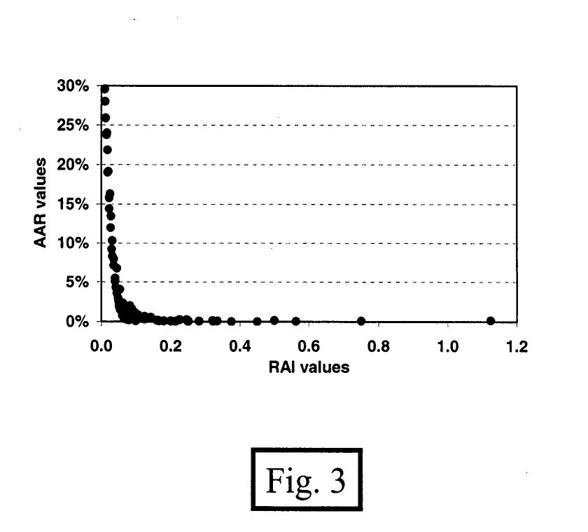

Based on optical modeling of a series of black matrix structures, it was determined that there is a strong correlation between the achievable AAR, the RAI of the graded absorber (contrast enhancing matrix layer). Specifically, in order to obtain an AAR of less than 5% at any given wavelength, the RAI should be greater than 0.05. In order to obtain an AAR of less than 2%, the RAI should be greater than 0.2, and in order to obtain an AAR of less than 0.5%, the RAI should be greater than 0.5. FIG. 3 shows a plot of a large number of black matrix optical calculations at a variety of refractive index values for the graded absorber (contrast enhancing matrix layer) (all with transparent substrate refractive index of n=1.6, and opaque layer of n=4, k=4, and T=100 nm, similar to chromium in the visible part of the spectrum).

As an example, if the value of k(t) for the graded absorber (contrast enhancing matrix layer) were to vary from 0 to 2.5 in a linear fashion for light of wavelength 550 nm, for a layer which is 100 nm thick, then the value of RAI (550 nm) would be (0.0+2.5)*100 nm/(2*550 nm), or 0.227, which would be a preferred value for a black matrix with an AAR of less than 2%.

When working with low RAI values, which are less preferred, a significant amount of light energy reflects off of opaque layer 112, and unless the structure is properly tuned, will result in significant reflectivity of the graded contrast enhancing matrix layer, preferably a black matrix layer. Since the contrast enhancing matrix layer is expected to perform at multiple angles and wavelengths, tuning the various reflections is difficult, and the best approach is to avoid them altogether by maintaining a higher RAI. The absorption of the graded contrast enhancing layer may tuned with respect to the illuminant to minimize heating.

Another possibility, which could occur as one strives to make the thinnest possible contrast enhancing matrix layer, is that if the graded absorber (contrast enhancing matrix layer) were to change optical constants too quickly, light could be reflected off of the gradient, even though there is not an abrupt interface. A strong gradient will produce a strong reflection. Therefore, it is advisable to avoid large index gradients in the graded absorber (contrast enhancing matrix layer). This effect scales with the wavelength of light, so a dimensionless quantity, the Reduced Index Gradient (RIG), will be defined as:

$$RIG ( λ ) = \frac{λ}{T} * \sqrt{Δ {n}^{2} + Δ {k}^{2}} .$$

RIG could be calculated for the entire graded layer, or for a slice of the graded layer. If n and k vary linearly, the two values will be identical. If there is a large gradient for some fraction of the layer, the slice value would be higher, indicating that this could be a detrimental situation. Optical modeling of graded layers indicates that the value of RIG for the graded layer or any part thereof should be kept below 25, and preferably below 10, and most preferably below 5.

In summary, a graded contrast enhancing matrix layer, preferably a black matrix layer, including a graded absorber (contrast enhancing matrix layer), should satisfy the requirements summarized in the first 3 columns of Table A for each wavelength of interest. Adhering to these design criteria should result in the quality metric listed in the final column. This summary is a guideline. It may be possible to find an example outside of this summary. All models assumed that variations in the graded absorber (contrast enhancing matrix layer) are linear with respect to both real and imaginary refractive index. The use of real materials will not permit this linearity at all wavelengths simultaneously.

TABLE A
Design parameters for contrast enhancing matrix layer with
a graded absorber (contrast enhancing matrix layer).

| | Interfacial | Reduced | Reduced | Angle |
|---|---|---|---|---|
| | Index | Absorption | Index | Averaged |
| | Discontinuity | Integral | Gradient | Reflectivity |
| | (IID) | (RAI) | (RIG) | (AAR) |
| Nominal | <0.60 | >0.05 | <25 | <5.0% |
| Preferred | <0.35 | >0.20 | <10 | <2.0% |
| Most Preferred | <0.25 | >0.50 | <5 | <0.5% |

The contrast enhancing matrix layer may be applied by a method such as printing, stamping, photolithography, vapor deposition or sputtering with a shadow mask. The optical density of the contrast enhancing matrix layer may be higher than 0.5, preferably higher than 1. Depending on the material of the contrast enhancing matrix layer and the process used to dispose the contrast enhancing matrix layer, the thickness of the contrast enhancing matrix may vary from 100 nm to 1000 nm, preferably from 150 nm to 300 nm.

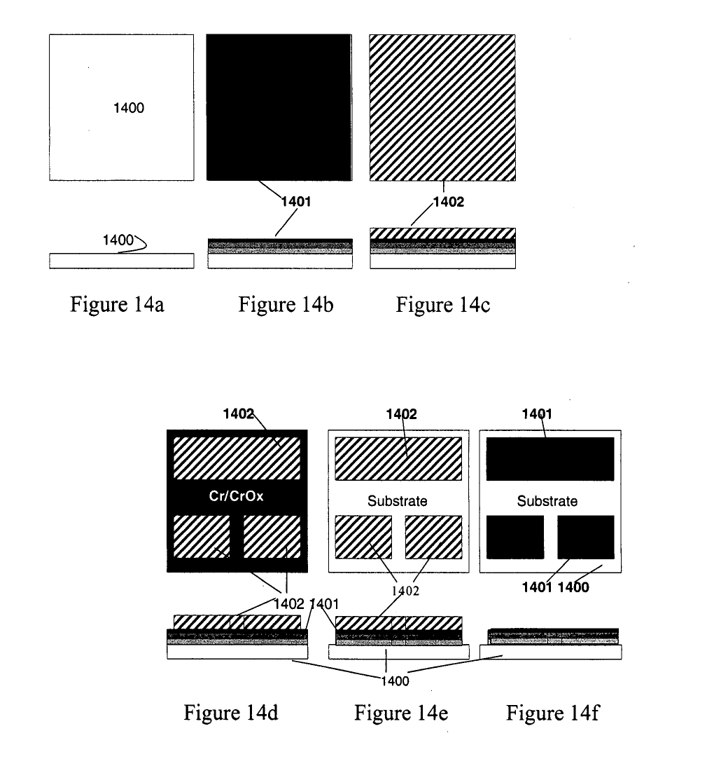

In one embodiment as shown in FIG. 14, a uniform coating of the graded contrast enhancing layer may be modified to form a black graded contrast enhancing matrix layer, with registration through a photomask using a photosensitive coating. The photosensitive coating may be a positively-working or negatively-working resist. When a positively-working resist is used, the photomask should have openings corresponding to regions where the contrast enhancing layer will be removed to leave a matrix. In this scenario, the photosensitive coating in the areas (exposed) is removed by a developer after exposure and an etchant removes the contrast enhancing layer where the resist has been removed. If a negatively-working resist is used, the photomask should have openings corresponding to the regions where the contrast enhancing layer will be remain to leave a matrix. In this scenario, the photosensitive black coating in the areas (unexposed) is removed by a developer after exposure and an etchant removes the contrast enhancing layer where the resist has been removed. The solvent(s) used to apply the photosensitive coating and the developer(s) and etchant(s) for removing the coating should be carefully selected so that they do not attack the surrounding layer(s).

Alternatively, a colorless photosensitive ink-receptive layer may be applied onto the top sealing layer followed by exposure through a photomask. If a positively-working photosensitive latent ink-receptive layer is used, the photomask should have openings corresponding to regions where the colorless photosensitive layer will form a visible matrix. In this scenario, after exposure, the exposed areas become ink-receptive or tacky and a contrast enhancing matrix layer may be formed on the exposed areas after an ink or toner is applied onto those areas. Alternatively, a negatively-working photosensitive ink-receptive layer may be used. In this case, the photomask should have openings corresponding to regions where the colorless photosensitive layer will remain colorless and after exposure, the exposed areas are hardened while a contrast enhancing matrix layer may be formed on the unexposed areas after a black ink or toner is applied onto those areas. The contrast enhancing matrix layer may be post cured by heat or flood exposure to improve the film integrity and physicomechanical properties.

In simplest form, the very low reflectance optical composite of the present invention includes a substrate and a low reflectance coating formed on the substrate. This low reflectance layer, referred to herein as the graded contrast enhancing matrix layer may comprise a single layer containing a gradient internal to the layer. The low reflectance layer may also comprise a number of sub-layers combining to make up the overall low reflectance layer. In one embodiment utilizing sub-layers, pairs of alternating layers of material and an oxide of the material such as chromium oxide and chromium, silicon oxide and silicon, titanium oxide and titanium, and tantalum oxide and tantalum are combined to produce the overall graded contrast enhancing matrix layer. Preferably the material is a metal. Preferably the sub-layer of material nearest/adjacent the substrate is relatively thin.

The substrate can be any material used for supporting an imaging element. Preferably, the support is any flexible self supporting plastic film that supports the thin conductive metallic film. “Plastic” means a high polymer, usually made from polymeric synthetic resins, which may be combined with other ingredients, such as curatives, fillers, reinforcing agents, colorants, and plasticizers. Plastic includes thermoplastic materials and thermosetting materials.

The flexible plastic film must have sufficient thickness and mechanical integrity so as to be self supporting, yet should not be so thick as to be rigid. Typically, the flexible plastic substrate is the thickest layer of the composite film in thickness. Consequently, the substrate determines to a large extent the mechanical and thermal stability of the fully structured composite film. Preferably, the substrate is non-conductive.

Another significant characteristic of the flexible plastic substrate material is its glass transition temperature (Tg). Tg is defined as the glass transition temperature at which plastic material will change from the glassy state to the rubbery state. It may comprise a range before the material may actually flow. Suitable materials for the flexible plastic substrate include thermoplastics of a relatively low glass transition temperature, for example up to 150° C., as well as materials of a higher glass transition temperature, for example, above 150° C. The choice of material for the flexible plastic substrate would depend on factors such as manufacturing process conditions, such as deposition temperature, and annealing temperature, as well as post-manufacturing conditions such as in a process line of a displays manufacturer. Certain of the plastic substrates discussed below can withstand higher processing temperatures of up to at least about 200° C., some up to 3000-3500° C., without damage.

Typically, the flexible plastic substrate is polyethylene terephthalate (PET), polyethylene naphthalate (PEN), polyethersulfone (PES), polycarbonate (PC), polysulfone, a phenolic resin, an epoxy resin, polyester, polyimide, polyetherester, polyetheramide, cellulose acetate, aliphatic polyurethanes, polyacrylonitrile, polytetrafluoroethylenes, polyvinylidene fluorides, poly(methyl(x-methacrylates), an aliphatic or cyclic polyolefin, polyarylate (PAR), polyetherimide (PEI), polyethersulphone (PES), polyimide (PI), Teflon poly(perfluoro-alboxy) fluoropolymer (PFA), poly(ether ketone) (PEEK), poly(ether ketone) (PEK), poly(ethylene tetrafluoroethylene)fluoropolymer (PETFE), and poly(methyl methacrylate) and various acrylate/methacrylate copolymers (PMMA). Aliphatic polyolefins may include high density polyethylene (HDPE), low density polyethylene (LDPE), and polypropylene, including oriented polypropylene (OPP). Cyclic polyolefins may include poly(bis(cyclopentadiene)). A preferred flexible plastic substrate is a cyclic polyolefin or a polyester. Various cyclic polyolefins are suitable for the flexible plastic substrate. Examples include Arton® made by Japan Synthetic Rubber Co., Tokyo, Japan; Zeanor T made by Zeon Chemicals L.P., Tokyo Japan; and Topas® made by Celanese A. G., Kronberg Germany. Arton is a poly(bis(cyclopentadiene)) condensate that is a film of a polymer. Alternatively, the flexible plastic substrate can be a polyester. A preferred polyester is an aromatic polyester such as Arylite. Although various examples of plastic substrates are set forth above, it should be appreciated that the substrate can also be formed from other materials such as glass and quartz.

The flexible plastic substrate can be reinforced with a hard coating. Typically, the hard coating is an acrylic coating. Such a hard coating typically has a thickness of from 1 to 15 microns, preferably from 2 to 4 microns and can be provided by free radical polymerization, initiated either thermally or by ultraviolet radiation, of an appropriate polymerizable material. Depending on the substrate, different hard coatings can be used. When the substrate is polyester or Arton, a particularly preferred hard coating is the coating known as “Lintec”. Lintec contains UV cured polyester acrylate and colloidal silica. When deposited on Arton, it has a surface composition of 35 atom % C, 45 atom % 0, and 20 atom % Si, excluding hydrogen. Another particularly preferred hard coating is the acrylic coating sold under the trademark “Terrapin” by Tekra Corporation, New Berlin, Wis.

The graded contrast enhancing matrix layer, preferably a black matrix layer, may be used in any reflective, transmissive, and self-luminous display technology that requires a light absorbing, typically colored or dark matrix to preserve the luminance contrast. In the preferred embodiment, a black graded contrast enhancing matrix layer is used in a reflective display, most preferably, an electrophoretic display. The electrophoretic display is a non-emissive device based on the electrophoresis phenomenon of charged pigment particles suspended in a solvent. It was first proposed in 1969. The display usually comprises two plates with electrodes placed opposing each other, separated by using spacers. One of the electrodes is usually transparent. A suspension composed of a colored solvent and charged pigment particles is enclosed between the two plates. When a voltage difference is imposed between the two electrodes, the pigment particles migrate to one side and then either the color of the pigment or the color of the solvent can be seen according to the polarity of the voltage difference.

In general, the display contains two electrodes, also referred to as conductive layers, with a layer of cells located between the electrode layers. At least one of the two conductive layers is patterned. In a first transmissive or reflective state, particles are assembled on (or between) one or more transparent viewing electrode(s). In a second transmissive or reflective state, the particles are removed from the viewing electrode(s) and collected on at least one collector electrode.

Other electrophoretic devices are based on the electric field induced motion of charged particles between electrodes in the same plane, referred to as in-plane electrophoretic displays (EPD). In in-plane electrode devices, collector electrodes are provided adjacent to and in the same plane as a viewing electrode (See for example, (see Kishi, E et al., Development of In-plane EPD,” SID 2000, pp. 24-27); Liang et al. US 2003/0035198. See also U.S. Pat Appl. Nos. 2001/0008582 A1, 2003/0227441 A1, 2001/0006389 A1, and U.S. Pat. Nos. 6,424,387, 6,269,225, and 6,104,448, all incorporated herein by reference.). In-plane devices have also been called “horizontal migration type electrophoretic display device,” (see U.S. Pat. No. 6,741,385). A display utilizing in-plane electrodes will have two conductive layers placed on the same side of the active area comprising comprising an electrically modulated imaging material. In the case of in-plane switching, one of the two electrode layers may be replaced by an insulating substrate layer.

Other reflective displays that benefit from the use of a graded contrast enhancing layer include electrochromic and electrowetting devices. Electrochromic devices, such as those described in U.S. Ser. No. 10/813,885 and references therein, incorporated herein by reference, evoke a color change in a material caused by the passage of an electric current potential. Traditional electrochromic materials rely on a dye that must serve as both the redox material and the color-changing agent. This dual purposing of the material results in limitations to contrast, lifetime (number of cycles), and available color sets. A particular type of electrochromic device is a halochromic device, such as described in U.S. Pat. No. 6,879,424, incorporated herein by reference. Such a device utilizes pH gradients induced by a reversible redox reaction between two electrodes. This pH gradient activates and alters the spectral absorption of the incorporated indicator dye, forming the basis for controlling the spectral reflectance of a pixel. Such a device is unique in that it separates the electrochomic mechanism into a colorless redox material and a chromatic pH sensitive color dye. This separation of mechanisms, while adding complexity and interactive dependencies, expands the capabilities in terms of contrast, lifetime, and available color sets relative to conventional electrochromic devices. Electrowetting devices, such as those described in WO 2005096065, GB 0526230.8, WO 2005096067, and GB0407643.6, incorporated herein by reference, provide light modulation by voltage driven surface energy changes that result in the movement of liquid materials.

The display contains at least one conductive layer, which typically is comprised of a primary metal oxide. This conductive layer may comprise other metal oxides such as indium oxide, titanium dioxide, cadmium oxide, gallium indium oxide, niobium pentoxide and tin dioxide. See, Int. Publ. No. WO 99/36261 by Polaroid Corporation. In addition to the primary oxide such as ITO, the at least one conductive layer can also comprise a secondary metal oxide such as an oxide of cerium, titanium, zirconium, hafnium and/or tantalum. See, U.S. Pat. No. 5,667,853 to Fukuyoshi et al. (Toppan Printing Co.). Other transparent conductive oxides include, but are not limited to ZnO₂, Zn₂SnO₄, Cd₂SnO₄, Zn₂In₂O₅, MgIn₂O₄, Ga₂O₃—In₂O₃, or TaO₃. The conductive layer may be formed, for example, by a low temperature sputtering technique or by a direct current sputtering technique, such as DC-sputtering or RF-DC sputtering, depending upon the material or materials of the underlying layer. The conductive layer may be a transparent, electrically conductive layer of tin oxide or indium-tin oxide (ITO), or polythiophene, with ITO being the preferred material. Typically, the conductive layer is sputtered onto the substrate to a resistance of less than 250 ohms per square. Alternatively, conductive layer may be an opaque electrical conductor formed of metal such as copper, aluminum or nickel. If the conductive layer is an opaque metal, the metal can be a metal oxide to create a light absorbing conductive layer.

Indium tin oxide (ITO) is the preferred conductive material, as it is a cost effective conductor with good environmental stability, up to 90% transmission, and down to 20 ohms per square resistivity. An exemplary preferred ITO layer has a % T greater than or equal to 80% in the visible region of light, that is, from greater than 400 nm to 700 nm, so that the film will be useful for display applications. In a preferred embodiment, the conductive layer comprises a layer of low temperature ITO which is polycrystalline. The ITO layer is preferably 10-120 nm in thickness, or 50-100 nm thick to achieve a resistivity of 20-60 ohms/square on plastic. An exemplary preferred ITO layer is 60-80 nm thick.

The conductive layer is preferably patterned. The conductive layer is preferably patterned into a plurality of electrodes. In another embodiment, two conductive substrates are positioned facing each other and electrically modulated imaging materials are positioned therebetween to form a device. The patterned ITO conductive layer may have a variety of dimensions. Exemplary dimensions may include line widths of 10 microns, distances between lines, that is, electrode widths, of 200 microns, depth of cut, that is, thickness of ITO conductor, of 100 nanometers. ITO thicknesses on the order of 60, 70, and greater than 100 nanometers are also possible.

The display may also contain a second conductive layer. The second conductive layer desirably has sufficient conductivity to carry a field across the electrically modulated imaging layer. The second layer can be on the same side of the imaging layer as the first conductive layer, in the case of in-plane switching, or on the side of the imaging layer opposite the first conductive layer. The second conductive layer may be formed in a vacuum environment using materials such as aluminum, tin, silver, platinum, carbon, tungsten, molybdenum, or indium. Oxides of these metals can be used to darken patternable conductive layers. The metal material can be excited by energy from resistance heating, cathodic arc, electron beam, sputtering or magnetron excitation. The second conductive layer may comprise coatings of tin oxide or indium-tin oxide, resulting in the layer being transparent. Alternatively, second conductive layer may be printed conductive ink.

For higher conductivities, the second conductive layer may comprise a silver based layer which contains silver only or silver containing a different element such as aluminum (Al), copper (Cu), nickel (Ni), cadmium (Cd), gold (Au), zinc (Zn), magnesium (Mg), tin (Sn), indium (In), tantalum (Ta), titanium (Ti), zirconium (Zr), cerium (Ce), silicon (Si), lead (Pb) or palladium (Pd). In a preferred embodiment, the conductive layer comprises at least one of gold, silver and a gold/silver alloy, for example, a layer of silver coated on one or both sides with a thinner layer of gold. See, Int. Publ. No. WO 99/36261 by Polaroid Corporation. In another embodiment, the conductive layer may comprise a layer of silver alloy, for example, a layer of silver coated on one or both sides with a layer of indium cerium oxide (InCeO). See U.S. Pat. No. 5,667,853, incorporated herein in by reference.

The second conductive layer may be patterned irradiating the multilayered conductor/substrate structure with ultraviolet radiation so that portions of the conductive layer are ablated therefrom. It is also known to employ an infrared (IR) fiber laser for patterning a metallic conductive layer overlying a plastic film, directly ablating the conductive layer by scanning a pattern over the conductor/film structure. See: Int. Publ. No. WO 99/36261, both incorporated herein by reference.

The display may also have separator structure to divide the electrically modulated imaging material into active sub-areas, referred to as cells. Preferably, the structure utilizes partition walls separating the active area into active cell areas. The partition walls are part of the inactive area of the display. In general, the electrophoretic cells can be of any shape, and their sizes and shapes may vary. The cells may be of substantially uniform size and shape. However, cells having a mixture of different shapes and sizes may be produced. The openings of the cells may be round, square, rectangular, hexagonal, or any other shape. The partition area between the openings is preferably kept small in order to achieve a high color saturation and contrast while maintaining desirable mechanical properties. A honeycomb-shaped opening can also be used.

For reflective electrophoretic displays, the dimension of each individual cell is determined based on desired display size and application. Some exemplary dimensions may be in the range of from 140 (180 dpi) to 2540 (10 dpi) microns, preferably from 320 (80 dpi) to 2540 (10 dpi) microns, depending on size of the display. The depth of the cells is in the range of about 3 to about 100 microns, preferably from about 5 to about 25 microns. The ratio between the area of opening to the total area (fill factor) is in the range of from about 0.05 to about 0.95, preferably from about 0.4 to about 0.9. The width of the openings usually are in the range of from about 15 to about 450 microns, preferably from about 25 to about 300 microns from edge to edge of the openings for a display with individual cells 500 by 500 microns.

The cells are filled with charged pigment particles dispersed in a colored dielectric solvent. The dispersion may be prepared according to methods well known in the art such as U.S. Pat. Nos. 6,017,584, 5,914,806, 5,573,711, 5,403,518, 5,380,362, 4,680,103, 4,285,801, 4,093,534, 4,071,430, 3,668,106 and IEEE Trans. Electron Devices, ED-24, 827 (1977), and J. Appl. Phys. 49(9), 4820 (1978). The charged pigment particles visually contrast with the medium in which the particles are suspended. The medium is a dielectric solvent which preferably has a low viscosity and a dielectric constant in the range of about 1 to about 30, preferably about 1.5 to about 15 for high particle mobility. Examples of suitable dielectric solvents include hydrocarbons such as decahydronaphthalene (DECALIN), 5-ethylidene-2-norbornene, fatty oils, paraffin oil, aromatic hydrocarbons such as toluene, xylene, phenylxylylethane, dodecylbenzene and alkylnaphthalene, halogenated solvents such as perfluorodecalin, perfluorotoluene, perfluoroxylene, dichlorobenzotrifluoride, 3,4,5-trichlorobenzotrifluoride, chloropentafluoro-benzene, dichlorononane, pentachlorobenzene, and perfluoro solvents such as FC-43®, FC-70® and FC-5060® from 3M Company, St. Paul Minn., low molecular weight halogen containing polymers such as poly(perfluoropropylene oxide) from TCI America, Portland, Oreg., poly(chlorotrifluoroethylene) such as Halocarbon Oils from Halocarbon Product Corp., River Edge, N.J., perfluoropolyalkylether such as Galden® from Ausimont or Krytox® Oils and Greases K-Fluid Series from DuPont, Del. In one preferred embodiment, poly(chlorotrifluoroethylene) is used as the dielectric solvent. In another preferred embodiment, poly(perfluoropropylene oxide) is used as the dielectric solvent.

For a black/white electrophoretic display, the suspension comprises charged white particles of titanium oxide (TiO₂) dispersed in a black solvent or charged black particles dispersed in a dielectric solvent. A black dye or dye mixture such as Pylam® Spirit Black and Fast Spirit Black from Pylam Products Co. Arizona, Sudan Black B from Aldrich, Thermoplastic Black X-70® from BASF, or an insoluble black pigment such as carbon black may be used to generate the black color of the solvent. Carbonaceous particles, particularly submicron carbonaceous particles, prepared from organic compounds such as coal tar, petroleum pitch or resins by a high temperature carbonizing process as taught in U.S. Pat. Nos. 5,332,517 and 5,693,367 may also be used as the black colorant.

In addition to the charged primary pigment particles such as TiO 2 particles, the electrophoretic fluid may be colored by a contrasting colorant. The contrast colorant may be formed from dyes or pigments.

Nonionic azo, anthraquinone and phthalocyanine dyes or pigments are particularly useful. Other examples of useful dyes include, but are not limited to: Oil Red EGN, Sudan Red, Sudan Blue, Oil Blue, Macrolex Blue, Solvent Blue 35, Pylam Spirit Black and Fast Spirit Black from Pylam Products Co., Arizona, Sudan Black B from Aldrich, Thermoplastic Black X-70 from BASF, anthraquinone blue, anthraquinone yellow 114, anthraquinone reds 111 and 135 and anthraquinone green 28 from Aldrich. In case of an insoluble pigment, the pigment particles for generating the color of the medium may also be dispersed in the dielectric medium. These color particles are preferably uncharged. If the pigment particles for generating color in the medium are charged, they preferably carry a charge which is opposite from that of the charged pigment particles. If both types of pigment particles carry the same charge, then they should have different charge density or different electrophoretic mobility. In any case, the dye or pigment for generating color of the medium must be chemically stable and compatible with other components in the suspension.

For example, electrophoretic cells filled with a dispersion of the red color may have a different shape or size from the green cells or the blue cells. Furthermore, a pixel may consist of different numbers of cells of different colors. For example, a pixel may consist of a number of small green cells, a number of large red cells, and a number of small blue cells. It is not necessary to have the same shape and number for the three colors.

The charged pigment particles may be organic or inorganic pigments, such as TiO₂, phthalocyanine blue, phthalocyanine green, diarylide yellow, diarylide AAOT Yellow, and quinacridone, azo, rhodamine, perylene pigment series from Sun Chemical, Hansa yellow G particles from Kanto Chemical, and Carbon Lampblack from Fisher. Submicron particle size is preferred. The particles should have acceptable optical characteristics, should not be swollen or softened by the dielectric solvent, and should be chemically stable. The resulting suspension must also be stable against sedimentation, creaming or flocculation under normal operating conditions.

The pigment particles may exhibit a native charge, or may be charged explicitly using a charge control agent, or may acquire a charge when suspended in the dielectric solvent. Suitable charge control agents are well known in the art; they may be polymeric or non-polymeric in nature, and may also be ionic or non-ionic, including ionic surfactants such as Aerosol OT, sodium dodecylbenzenesulfonate, metal soap, polybutene succinimide, maleic anhydride copolymers, vinylpyridine copolymers, vinylpyrrolidone copolymer (such as Ganex® from International Specialty Products), (meth)acrylic acid copolymers, and N,N-dimethylaminoethyl (meth)acrylate copolymers. Fluorosurfactants are particularly useful as charge controlling agents in fluorocarbon solvents. These include FC fluorosurfactants such as FC-170C®, FC-171®, FC-176®, FC430®, FC431® and FC-740® from 3M Company and Zonyl® fluorosurfactants such as Zonyl® FSA, FSE, FSN, FSN-100, FSO, FSO-100, FSD and UR from Dupont.

Suitable charged pigment dispersions may be manufactured by any of the well-known methods including grinding, milling, attriting, microfluidizing, and ultrasonic techniques. For example, pigment particles in the form of a fine powder are added to the suspending solvent and the resulting mixture is ball milled or attrited for several hours to break up the highly agglomerated dry pigment powder into primary particles. Although less preferred, a dye or pigment for generating color of the suspending medium may be added to the suspension during the ball milling process.

Sedimentation or creaming of the pigment particles may be eliminated by microencapsulating the particles with suitable polymers to match the specific gravity to that of the dielectric solvent. Microencapsulation of the pigment particles may be accomplished chemically or physically. Typical microencapsulation processes include interfacial polymerization, in-situ polymerization, phase separation, coacervation, electrostatic coating, spray drying, fluidized bed coating and solvent evaporation.

For a subtractive color system, the charged TiO 2 particles may be suspended in a dielectric solvent of cyan, yellow or magenta color. The cyan, yellow or magenta color may be generated via the use of a dye or a pigment. For an additive color system, the charged TiO 2 particles may be suspended in a dielectric solvent of red, green or blue color generated also via the use of a dye or a pigment.

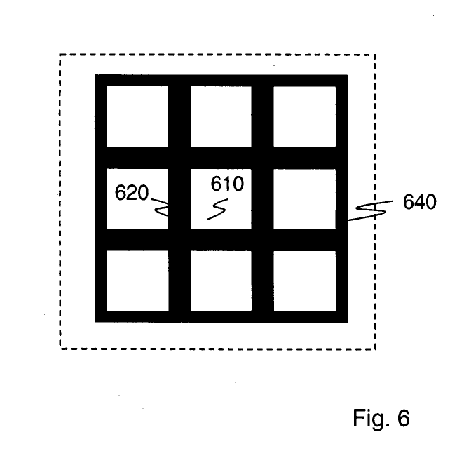

An application of black matrix is illustrated using an in-plane-switching (IPS) electrophoretic (EP) display device. FIG. 6 shows a 3×3 electrophoretic display cell array 600. This cell array 600 has two distinct areas: active area 610 and inactive area 620. The luminance level of the active area 610 can be modulated by electric field to show a visible luminance change to form the white and black states of the display. The inactive area 620 cannot be modulated, and hence has a constant luminance appearance. A black graded contrast enhancing matrix 640, the entire black area, is used to cover all or part of the inactive area.

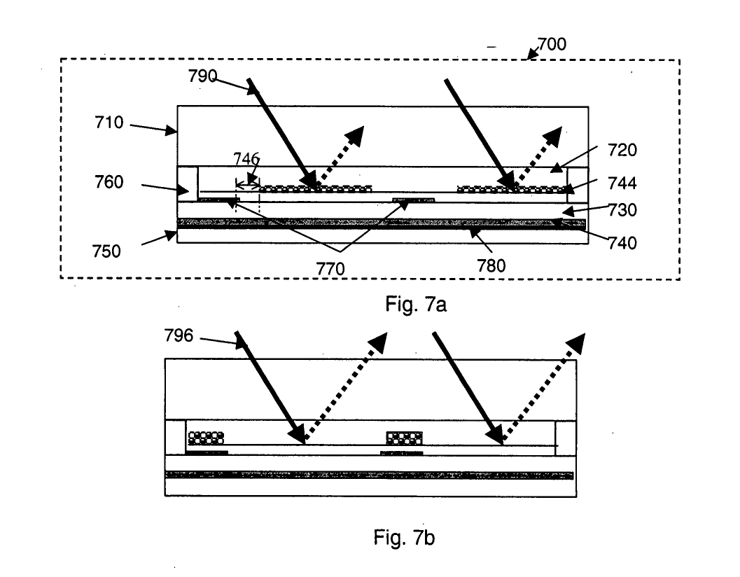

FIG. 7 illustrated a cell configuration for an in-plane-switching electrophoretic cell 700 from prior art. This cell has a top substrate layer 710, a transparent dielectric fluid layer 720, an upper insulating layer 730, a middle insulating and reflection layer 740, and a bottom substrate layer 750. A spacer or cell wall 760 sets the boundary for individual cells. There are two driving electrodes 770 and 780, the electric field between which controls the location of the black particles 744. There may be a gap 746 between the driving electrode 780 and the black particles 744, as required by the ease of control of particle movement. In FIG. 7(a) the black particles are located away from the driving electrode 770. A light ray 790 hits the black particles, and gets mostly absorbed. The resulting appearance is a black pixel. In FIG. 7(b) the black particles are located above the driving electrode 770. A light ray 796 hits the cell reflecting layer, and gets mostly reflected. The resulting appearance is a white pixel.

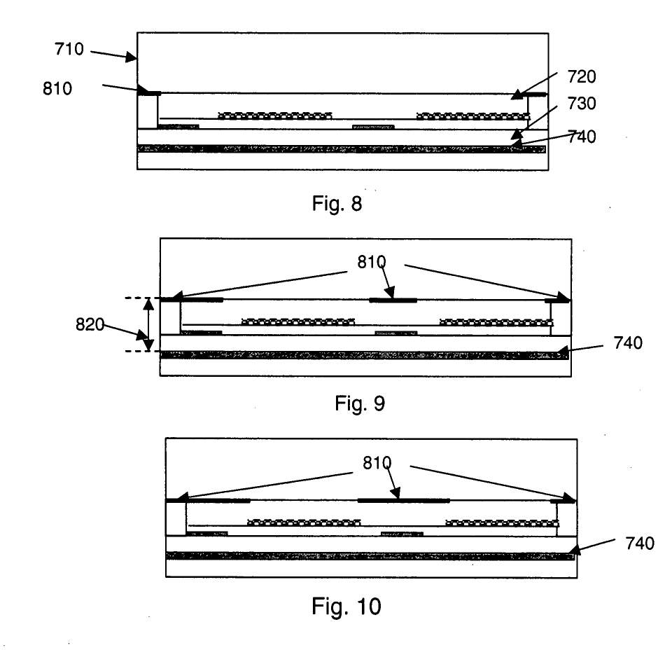

A black matrix is frequently used to cover part of the cell area. The black matrix is patterned appropriately to obtain a low reflectance dark state, that is, so that it covers those areas that if left free of mask, would result in higher dark state reflectance and hence poorer contrast. There are several choices of applying a black matrix in terms of area coverage. FIG. 8 illustrate three of such choices. In FIG. 8 only the top of the cell wall 760 is covered by the contrast enhancing black matrix 810. In FIG. 9 the top of the cell wall 760 as well as the top of the driving electrode 780 are covered the contrast enhancing black matrix 810. In FIG. 10 the coverage of the contrast enhancing black matrix 810 extends to cell wall 760, driving electrode 780, and the gap 746. With each increase in coverage the black state luminance level is reduced. This frequently results in an increase in luminance contrast of the cell. Example 6 will show some numeric results of the luminance contrast as a function of the black matrix coverage for a particular cell configuration. It should be noted that the white state luminance level also reduced with the increase in black matrix coverage. The two aspects, white state luminance level and luminance contrast, need to be co-optimized to produce a display with high image quality.

The optical property of the black matrix is another important factor to consider when applying the black matrix. It is generally agreed that an ideal black matrix should have low reflectance of the top surface and a low transmittance. The bottom surface of the black matrix is generally omitted from the specifications. Our study shows that in the configuration of in-plane-switching electrophoretic display it is also desirable for the bottom of the black matrix to have a high reflectance. This high reflectance will make the cell insensitive to the vertical location of the black matrix, improving the robustness of the manufacturing process of the display device. Example 7 will show some numeric results of the luminance contrast as a function of the black matrix coverage for a particular cell configuration.

Reflectivity of a surface is a function of incidence angle, wavelength, and polarization. For this application, it is preferred that the surface be highly reflecting at all angles, wavelengths, and polarizations. It is reasonable to obtain a metric, which averages over angles and polarizations, but meets a particular specification at each color (wavelength), which is relevant to the device. In a preferred embodiment, the reflectance of the graded contrast enhancing matrix layer at the point farthest from the substrate, i.e., the bottom of the contrast enhancing layer, will provide an Angle Averaged Reflectivity (AAR) in excess of 40% at all wavelengths generated by the device, and a wavelength averaged value (AAR) in excess of 60%.

An optically thick silver coating (100 nm) on glass provides 86% reflectivity at 400 nm, and 95% at 720 nm for light propagating at all angles within the glass. 100 nm of Aluminum provides 90% reflectivity at 400 nm, and 84% at 720 nm. Chromium does not provide a high reflective surface by the current definition, providing only 53% reflectivity at 400 nm, and 40% at 720 nm. Gold reflectivity is 94% at 720 nm, but only 31% at 400 nm. Preferably, the bottom surface of the contrast enhancing layer is a reflectors, such as Ag, Al, Mg, Pt, Pd, Ir, Ni, Ta, Sn, Sb, In and Ti, for broad band (white & RGB (Red Green Blue)) applications, and Cu and Au are suitable for red only applications. It is also possible to add a separate reflector layer to the bottom surface of the contrast enhancing layer. The reflectors such as Ag, Al, Mg, Pt, Pd, Ir, Ni, Ta, Sn, Sb, In and Ti, for broad band (white & RGB (Red Green Blue)) applications, and Cu and Au are suitable, as above.

White diffuse reflectors can also be used. Preferred materials would be suspensions of particles of dielectric materials in the 0.1 to 10 micron size range forming a layer of thickness ranging from 1 to 100 times the particle size. Preferred particulate layers can contain particles of oxides of Ti, Zr, Zn as well as zinc sulfide. Such particles may be coated with a protective layer such as silicon oxide.

In FIG. 9, the positioning of the graded contrast enhancing matrix layer, here, a black matrix layer, refers to the distance of the contrast enhancing matrix layer 810 from the reflecting surface 740. The designed distance 910 of the two may be changed in manufacturing of the display. A robust design of the display needs to reduce the variation in luminance when the distance between the two surfaces varies.

In other embodiments, the graded contrast enhancing matrix layer may be used in different types of displays. In displays in general, at least one imageable layer is applied to a support. The imageable layer contains an electrically imageable material. The electrically imageable material can be light emitting or light modulating. Light emitting materials can be inorganic or organic in nature. Particularly preferred are organic light emitting diodes (OLED) or polymeric light emitting diodes (PLED). The light modulating material can be reflective or transmissive. Light modulating materials can be electrochemical, electrophoretic, such as GYRICON™ particles, electrochromic, or liquid crystals. The liquid crystalline material can be twisted nematic (TN), super-twisted nematic (STN), ferroelectric, magnetic, or chiral nematic liquid crystals. Especially preferred are chiral nematic liquid crystals. The chiral nematic liquid crystals can be polymer dispersed liquid crystals (PDLC). Structures having stacked imaging layers or multiple support layers, however, are optional for providing additional advantages in some case.

In a preferred embodiment, the electrically imageable material can be addressed with an electric field and then retain its image after the electric field is removed, a property typically referred to as “bistable”. Particularly suitable electrically imageable materials that exhibit “bistability” are electrochemical, electrophoretic, such as GYRICON™ particles, electrochromic, magnetic, or chiral nematic liquid crystals. Especially preferred are chiral nematic liquid crystals. The chiral nematic liquid crystals can be polymer dispersed liquid crystals (PDLC).

The electrically modulated material may be a printable, conductive ink having an arrangement of particles or microscopic containers or microcapsules. Each microcapsule contains an electrophoretic composition of a fluid, such as a dielectric or emulsion fluid, and a suspension of colored or charged particles or colloidal material. The diameter of the microcapsules typically ranges from about 30 to about 300 microns. According to one practice, the particles visually contrast with the dielectric fluid. According to another example, the electrically modulated material may include rotatable balls that can rotate to expose a different colored surface area, and which can migrate between a forward viewing position and/or a rear nonviewing position, such as GYRICON™ particles. Specifically, GYRICON™ particles are comprised of twisting rotating elements contained in liquid filled spherical cavities and embedded in an elastomer medium. The rotating elements may be made to exhibit changes in optical properties by the imposition of an external electric field. Upon application of an electric field of a given polarity, one segment of a rotating element rotates toward, and is visible by an observer of the display. Application of an electric field of opposite polarity, causes the element to rotate and expose a second, different segment to the observer. A GYRICON™ particle display maintains a given configuration until an electric field is actively applied to the display assembly. GYRICON™ particles typically have a diameter of about 100 microns. GYRICON™ materials are disclosed in U.S. Pat. No. 6,147,791, U.S. Pat. No. 4,126,854 and U.S. Pat. No. 6,055,091, the contents of which are herein incorporated by reference.

According to one practice, the microcapsules may be filled with electrically charged white particles in a black or colored dye. Examples of electrically modulated material and methods of fabricating assemblies capable of controlling or effecting the orientation of the ink suitable for use with the present invention are set forth in International Patent Application Publication Number WO 98/41899, International Patent Application Publication Number WO 98/19208, International Patent Application Publication Number WO 98/03896, and International Patent Application Publication Number WO 98/41898, the contents of which are herein incorporated by reference.

The electrically modulated material may also include material disclosed in U.S. Pat. No. 6,025,896, the contents of which are incorporated herein by reference. This material comprises charged particles in a liquid dispersion medium encapsulated in a large number of microcapsules. The charged particles can have different types of color and charge polarity. For example white positively charged particles can be employed along with black negatively charged particles. The described microcapsules are disposed between a pair of electrodes, such that a desired image is formed and displayed by the material by varying the dispersion state of the charged particles. The dispersion state of the charged particles is varied through a controlled electric field applied to the electrically modulated material. According to a preferred embodiment, the particle diameters of the microcapsules are between about 5 microns and about 200 microns, and the particle diameters of the charged particles are between about one-thousandth and one-fifth the size of the particle diameters of the microcapsules.

Further, the electrically modulated material may include a thermochromic material. A thermochromic material is capable of changing its state alternately between transparent and opaque upon the application of heat. In this manner, a thermochromic imaging material develops images through the application of heat at specific pixel locations in order to form an image. The thermochromic imaging material retains a particular image until heat is again applied to the material. Since the rewritable material is transparent, UV fluorescent printings, designs and patterns underneath can be seen through.

The electrically modulated material may also include surface stabilized ferroelectric liquid crystals (SSFLC). Surface stabilized ferroelectric liquid crystals confining ferroelectric liquid crystal material between closely spaced glass plates to suppress the natural helix configuration of the crystals. The cells switch rapidly between two optically distinct, stable states simply by alternating the sign of an applied electric field.

Magnetic particles suspended in an emulsion comprise an additional imaging material suitable for use with the present invention. Application of a magnetic force alters pixels formed with the magnetic particles in order to create, update or change human and/or machine readable indicia. Those skilled in the art will recognize that a variety of bistable nonvolatile imaging materials are available and may be implemented in the present invention.

The electrically modulated material may also be configured as a single color, such as black, white or clear, and may be fluorescent, iridescent, bioluminescent, incandescent, ultraviolet, infrared, or may include a wavelength specific radiation absorbing or emitting material. There may be multiple layers of electrically modulated material. Different layers or regions of the electrically modulated material display material may have different properties or colors. Moreover, the characteristics of the various layers may be different from each other. For example, one layer can be used to view or display information in the visible light range, while a second layer responds to or emits ultraviolet light. The nonvisible layers may alternatively be constructed of non-electrically modulated material based materials that have the previously listed radiation absorbing or emitting characteristics. The electrically modulated material employed in connection with the present invention preferably has the characteristic that it does not require power to maintain display of indicia.

There are alternative display technologies that can be used, for example, in flat panel displays. A notable example is organic or polymer light emitting devices (OLEDs) or (PLEDs), which are comprised of several layers in which one of the layers is comprised of an organic material that can be made to electroluminesce by applying a voltage across the device. An OLED device is typically a laminate formed in a substrate such as glass or a plastic polymer. A light emitting layer of a luminescent organic solid, as well as adjacent semiconductor layers, are sandwiched between an anode and a cathode. The semiconductor layers can be hole injecting and electron injecting layers. PLEDs can be considered a subspecies of OLEDs in which the luminescent organic material is a polymer. The light emitting layers may be selected from any of a multitude of light emitting organic solids, e.g., polymers that are suitably fluorescent or chemiluminescent organic compounds. Such compounds and polymers include metal ion salts of 8-hydroxyquinolate, trivalent metal quinolate complexes, trivalent metal bridged quinolate complexes, Schiff-based divalent metal complexes, tin (IV) metal complexes, metal acetylacetonate complexes, metal bidenate ligand complexes incorporating organic ligands, such as 2-picolylketones, 2-quinaldylketones, or 2-(o-phenoxy) pyridine ketones, bisphosphonates, divalent metal maleonitriledithiolate complexes, molecular charge transfer complexes, rare earth mixed chelates, (5-hydroxy) quinoxaline metal complexes, aluminum tris-quinolates, and polymers such as poly(p-phenylenevinylene), poly(dialkoxyphenylenevinylene), poly(thiophene), poly(fluorene), poly(phenylene), poly(phenylacetylene), poly(aniline), poly(3-alkylthiophene), poly(3-octylthiophene), and poly(N-vinylcarbazole). When a potential difference is applied across the cathode and anode, electrons from the electron injecting layer and holes from the hole injecting layer are injected into the light emitting layer; they recombine, emitting light. OLEDs and PLEDs are described in the following United States patents, all of which are incorporated herein by this reference: U.S. Pat. No. 5,707,745 to Forrest et al., U.S. Pat. No. 5,721,160 to Forrest et al., U.S. Pat. No. 5,757,026 to Forrest et al., U.S. Pat. No. 5,834,893 to Bulovic et al., U.S. Pat. No. 5,861,219 to Thompson et al., U.S. Pat. No. 5,904,916 to Tang et al., U.S. Pat. No. 5,986,401 to Thompson et al., U.S. Pat. No. 5,998,803 to Forrest et al., U.S. Pat. No. 6,013,538 to Burrows et al., U.S. Pat. No. 6,046,543 to Bulovic et al., U.S. Pat. No. 6,048,573 to Tang et al., U.S. Pat. No. 6,048,630 to Burrows et al., U.S. Pat. No. 6,066,357 to Tang et al., U.S. Pat. No. 6,125,226 to Forrest et al., U.S. Pat. No. 6,137,223 to Hung et al., U.S. Pat. No. 6,242,115 to Thompson et al., and U.S. Pat. No. 6,274,980 to Burrows et al.

In a typical matrix address light emitting display device, numerous light emitting devices are formed on a single substrate and arranged in groups in a regular grid pattern. Activation may be by rows and columns, or in an active matrix with individual cathode and anode paths. OLEDs are often manufactured by first depositing a transparent electrode on the substrate, and patterning the same into electrode portions. The organic layer(s) is then deposited over the transparent electrode. A metallic electrode can be formed over the electrode layers. For example, in U.S. Pat. No. 5,703,436 to Forrest et al., incorporated herein by reference, transparent indium tin oxide (ITO) is used as the hole injecting electrode, and a Mg—Ag-ITO electrode layer is used for electron injection.

In another embodiment, the display may be a “liquid crystal display” (LCD), which is a type of flat panel display used in various electronic devices. At a minimum, an LCD comprises a substrate, at least one conductive layer and a liquid crystal layer. The LCD may also include functional layers. In one typical embodiment of an LCD, a transparent, multilayer flexible support is coated with a first conductive layer, which may be patterned, onto which is coated the light modulating liquid crystal layer. A second conductive layer is applied and overcoated with a dielectric layer to which dielectric conductive row contacts are attached, including vias that permit interconnection between conductive layers and the dielectric conductive row contacts. An optional nanopigmented functional layer may be applied between the liquid crystal layer and the second conductive layer.

The liquid crystal (LC) is used as an optical switch. The substrates are usually manufactured with transparent, conductive electrodes, in which electrical “driving” signals are coupled. The driving signals induce an electric field which can cause a phase change or state change in the LC material, the LC exhibiting different light reflecting characteristics according to its phase and/or state.

Liquid crystals can be nematic (N), chiral nematic (N*), or smectic, depending upon the arrangement of the molecules in the mesophase. Chiral nematic liquid crystal (N*LC) displays are typically reflective, that is, no backlight is needed, and can function without the use of polarizing films or a color filter.

The display may also comprises at least one “functional layer” between the conductive layer and the substrate. The functional layer may comprise a protective layer or a barrier layer. The protective layer useful in the practice of the invention can be applied in any of a number of well known techniques, such as dip coating, rod coating, blade coating, air knife coating, gravure coating and reverse roll coating, extrusion coating, slide coating, curtain coating, and the like. The liquid crystal particles and the binder are preferably mixed together in a liquid medium to form a coating composition. The liquid medium may be a medium such as water or other aqueous solutions in which the hydrophilic colloid are dispersed with or without the presence of surfactants. A preferred barrier layer may acts as a gas barrier or a moisture barrier and may comprise SiOx, AlOx or ITO. The protective layer, for example, an acrylic hard coat, functions to prevent laser light from penetrating to functional layers between the protective layer and the substrate, thereby protecting both the barrier layer and the substrate. The functional layer may also serve as an adhesion promoter of the conductive layer to the substrate.

To complete the display assembly, a diffuser layer may be applied directly or indirectly above the black matrix layer to improve the visual effect of the finished display device.

In another embodiment, the polymeric support may further comprise an antistatic layer to manage unwanted charge build up on the sheet or web during roll conveyance or sheet finishing. In another embodiment of this invention, the antistatic layer has a surface resistivity of between 10⁵ to 10¹². Above 10¹², the antistatic layer typically does not provide sufficient conduction of charge to prevent charge accumulation to the point of preventing fog in photographic systems or from unwanted point switching in liquid crystal displays. While layers greater than 10⁵ will prevent charge buildup, most antistatic materials are inherently not that conductive and in those materials that are more conductive than 10⁵, there is usually some color associated with them that will reduce the overall transmission properties of the display. The antistatic layer is separate from the highly conductive layer of ITO and provides the best static control when it is on the opposite side of the web substrate from that of the ITO layer. This may include the web substrate itself.

The functional layer may also comprise a conductivity blocking layer. A conductivity blocking layer, for purposes of the present invention, is a layer that is not conductive or blocks the flow of electricity. This conductivity blocking material may include a UV curable, thermoplastic, screen printable material, such as Electrodag 25208 dielectric coating from Acheson Corporation. The conductivity blocking material forms a conductivity blocking layer. This layer may include openings to define image areas, which are coincident with the openings. Since the image is viewed through a transparent substrate, the indicia are mirror imaged.

The conductivity blocking material may form an adhesive layer to subsequently bond a second electrode to the light modulating layer. Conventional lamination techniques involving heat and pressure are employed to achieve a permanent durable bond. Certain thermoplastic polyesters, such as VITEL 1200 and 3200 resins from Bostik Corp., polyurethanes, such as MORTHANE CA-100 from Morton International, polyamides, such as UNIREZ 2215 from Union Camp Corp., polyvinyl butyral, such as BUTVAR B-76 from Monsanto, and poly(butyl methacrylate), such as ELVACITE 2044 from ICI Acrylics Inc. may also provide a substantial bond between the electrically conductive and light modulating layers.

The conductivity blocking adhesive layer may be coated from common organic solvents at a dry thickness of one to three microns. The conductivity blocking adhesive layer may also be coated from an aqueous solution or dispersion. Polyvinyl alcohol, such as AIRVOL 425 or MM-51 from Air Products, poly(acrylic acid), and poly(methyl vinyl ether/maleic anhydride), such as GANTREZ AN-119 from GAF Corp. can be dissolved in water, subsequently coated over the second electrode, dried to a thickness of one to three microns and laminated to the light modulating layer. Aqueous dispersions of certain polyamides, such as MICROMID 142LTL from Arizona Chemical, polyesters, such as AQ 29D from Eastman Chemical Products Inc., styrene/butadiene copolymers, such as TYLAC 68219-00 from Reichhold Chemicals, and acrylic/styrene copolymers such as RayTech 49 and RayKote 234L from Specialty Polymers Inc. can also be utilized as a conductivity blocking adhesive layer as previously described.

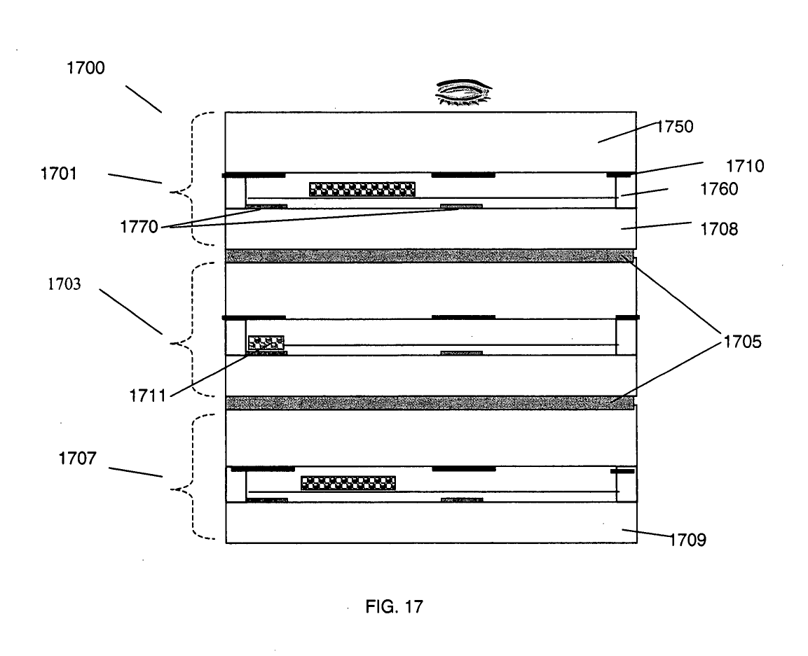

The stacked display unit 1700 shown in this FIG. 17 comprises three separate single display units comprising in order from the viewer single transparent display units 1701 and 1703 of different colors (comprising top transparent substrate 1750 and bottom transparent substrate 1708, patterned electrodes 1770 and a fluid containing cell formed by two sideways opposing cell partition walls 1760 and contrast enhancing layer 1710) and one single reflective display unit 1707 (comprising transparent substrate 1750 and white reflective substrate 1709), patterned electrodes 1770 and a fluid containing cell formed by two sideways opposing cell partition walls 1760 and contrast enhancing layer 1710) that are adhered together by adhesive layer 1705. The three separate single display units are registered in relation to each other to provide the maximum viewing aperture. The single transparent display unit comprises a top transparent substrate 1750 that has an adhesive layer (not shown) that is adhered to top of the cell partition walls 1760. The fluid containing cells are filled with a electroptic material 1711 with charged particles that move in relative position within the cell (substantially perpendicular to the viewing plane). For a stacked color display each single display unit may contain a different color electroptic particle. The contrast enhancing layer 1710 may extend part way over the cell containing the electroptic material or it may just reside on the top of the cell partition wall. This display provides the viewer with the greatest contrast between the contrast enhancing layer and the color being formed in the cell and therefore enhances the color saturation of the display. Additionally the extension of the contrast enhancing layer over the cell area beyond the partition walls provide an area in which the colored particles are substantially removed from the field of view of the observer. The boundary formed between the color enhancing layer and the electroptic color in the cell will appear to be sharper, more saturated and have better color purity. The contrast enhancing layer is optional for single display units 1703 and 1707. The following examples are provided to illustrate the invention.

### EXAMPLE 1

### Glass Sample of Black Matrix

A real sample of black matrix was made by coating multiple layers of Cr/CrOx on a glass substrate. The substrate was a 2.5″×2.5″ soda-lime glass with a thickness of 1.13 mm. The refractive index of the glass was 1.513 at 645 nm. An Edwards 306A thin film evaporator with DC sputtering attachment was used as a vacuum coater. A chromium target was put in the vacuum coater together with the glass substrate. The coating chamber was filled with a mixture of Argon and O₂ gas. The ratio of the two gases was controlled to create a thin layer of coating with distinctive optical constants on the substrate. The wattage and time were controlled to produce a specific thickness for a given layer. Four stacking layers were produced in a continuous coating process. When the predetermined coating time was near its end the gas Ar/O₂ mix was slowly changed to the value of the next layer, and the time taken to change from one layer to the next was about 10 seconds. The coating parameters are shown in Table 1.

TABLE 1
Coating parameters used in making the glass sample

| | | | | Layer | | | |
|---|---|---|---|---|---|---|---|
| | | O₂ gas | Ar gas | thick- | | Coating | |
| | Appear- | flow | flow | ness | Wattage | Pressure | Time |
| Layer | ance | (sccm) | (sccm) | (nm) | (w) | (μm) | (sec) |
| A | Clear | 2.1 | 19.9 | 20 | 100 | 5 | 480 |
| B | Medium | 1.0 | 16.0 | 80 | 100 | 5 | 180 |
| | gray | | | | | | |
| C | Dark | 0.6 | 14.4 | 50 | 200 | 3.3 | 90 |
| D | Clear | 2.1 | 19.9 | 20 | 100 | 5 | 480 |

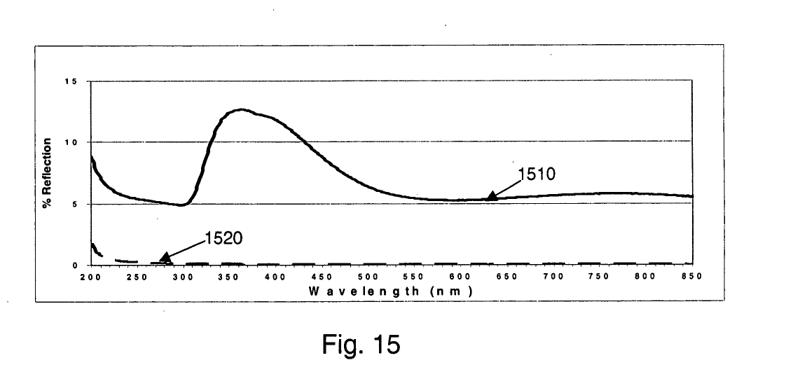

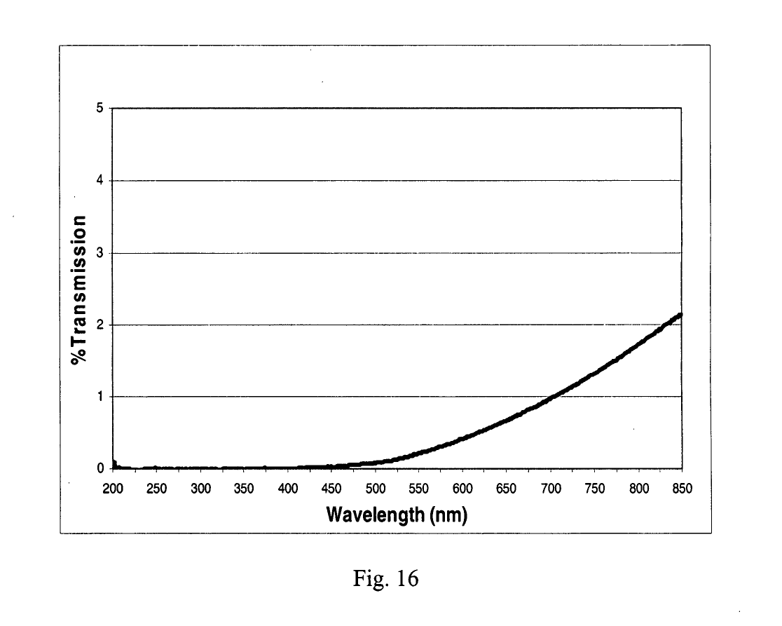

A PerkinElmer Lambda 800 UV/Visible Spectrophotometer was used to measure the optical effect of the black matrix. This device had a spectral range of 200 μm-850 μm. The illumination used collimated light 8° from the normal, and the detector receives the total light through a 150 mm integrating sphere transmitted or reflected from the sample. FIG. 15 shows the total reflectance 1510 and the diffuse reflection 1512 of the coated sample measured from the glass side (not the coating side). It can be seen that the diffuse component of the reflection is near zero. Therefore, the majority of the reflected light is in the specular direction. FIG. 16 shows the total transmittance of the coated sample measured also from the glass side. It is clearly seen that this black matrix sample made of multiple layers of thin film coating performs well as a black matrix. The total reflectance is low (6% or below) across a large range of the visible spectrum, i.e. 500 nm and up. The majority of this reflection is the reflected light from the top surface reflection of the glass substrate (4.2%, based on refractive index of 1.51). The reflectance from the black matrix is therefore less than 1.8%. The transmittance of the coating is also very low, i.e. <1% from 380 nm to 700 nm.

### EXAMPLE 2

### Graded Contrast Enhancing Layer Made up of Multiple Sub-Layers

Five films were prepared by reactive DC sputtering of a metallic chromium target, with different flow rates of oxygen through the chamber. Each of the materials was coated and the complex refractive indicies were measured by way of variable angle spectroscopic ellipsometry (VASE: Variable angle spectroscopic ellipsometry: A nondestructive characterization technique for ultrathin and multilayer materials. Woollam, J A; Snyder, P G; Rost, M C, THIN SOL. FILMS. Vol. 166, pp. 317-323. 1988).

Selected measured optical constants for these films are reported in Table 2. The first four films are non-stoichiometric oxide mixtures of chromium, referred to here as CrOₓ, and have been identified by their appearance as Clear, Light, Medium, Dark. The final column is metallic chromium, and was not analyzed. The reported values for metallic chromium are from Palik (Edward D. Palik, Handbook of Optical Constants of Solids, Academic Press Inc., (1985) and Edward D. Palik, Handbook of Optical Constants of Solids II, Academic Press Inc., (1991) and references therein, hereafter referred to as “Palik”). The full data (used in the calculations) span the visible spectrum, and include wavelengths every 10 nm.

TABLE 2
selected optical constants of DC Reactive Sputter Cr in Ar & O₂

| | | Appearance | | | | |
|---|---|---|---|---|---|---|
| | | Clear | Light | Medium | Dark | Metallic |
| Gas Flow | O₂ | 2.1 | 1.5 | 1.0 | 0.6 | 0.00 |
| Gas Flow | Ar | 19.9 | 17.5 | 16.0 | 14.4 | 12.0 |
| λ = 400 nm | n | 1.854 | 2.620 | 2.474 | 2.690 | 1.496 |
| λ = 400 nm | k | 0.117 | 0.349 | 0.939 | 1.596 | 3.592 |
| λ = 500 nm | n | 1.787 | 2.568 | 2.654 | 3.077 | 2.611 |
| λ = 500 nm | k | 0.001 | 0.162 | 0.845 | 1.553 | 4.456 |
| λ = 600 nm | n | 1.735 | 2.511 | 2.748 | 3.307 | 3.440 |
| λ = 600 nm | k | 0.000 | 0.096 | 0.778 | 1.446 | 4.366 |
| λ = 700 nm | n | 1.708 | 2.477 | 2.814 | 3.449 | 3.838 |
| λ = 700 nm | k | 0.000 | 0.069 | 0.733 | 1.360 | 4.370 |

A multi-layer optical modeling program using standard procedures based on the Fresnel equations was used to compute reflectivity of layered structures of the materials in Table 2, at various wavelengths, angles, and polarizations. The reflectivity was averaged over angles of 0 to 40 degrees (measured within the transparent substrate), and over wavelengths from 380 to 780 nm. The resulting AAR (Angle Averaged Reflectivity) was computed for each structure considered. The optimized structure would be the one with the lowest AAR, with total structure thickness being minimized as a secondary constraint.

A variety of layered structures were considered, each with over 1000 thickness variations in order to determine the optimized structure based on these five films to perform the functions of a black matrix. The optimized structure for a transparent substrate of PET (n=1.598, k=0) was 80 nm of clear CrOₓ, 40 nm of light CrOₓ, 40 nm of dark CrOₓ and 100 nm of metallic chromium. The computed value of AAR was 0.17%.

Important to note are the following facts. Metallic Cr is most effective at preventing light transmission, especially in the red. Clear CrOₓ will form an interface with most transparent substrates which reflects only a small amount of light. Subsequent layers of CrOₓ can gradually increase the absorption properties, and the value of n undergoes no sudden changes. The precise thicknesses of the layers can be used to minimize the small reflections, which occur at each optical interface. This optimization can be done through optical modeling, and verified experimentally. The object of the optimization is to prevent reflected energy at all wavelengths in the visible, at all incident angles, and for both TE and TM polarizations. This metric is easily computed using commercial or in-house software.

### EXAMPLE 3a

### Modeled Linear k Embodiment

An improvement to the multi-layer structure of Example 2, is to form a graded layer by continuously varying the level of oxidant present in the sputtering plasma. Using the full data summarized in Table 2, one can interpolate between the columns to obtain an estimate of the optical constants at a variety of oxidant levels. The specific interpolations were selected to provide a set of materials for which k (500 nm) varied in steps of 0.1 from 0.0 to 2.0. These data were then used to simulate a graded layer with a nearly continuously varying index, where specifically, the value of k (500 nm) varied linearly. The fact that the model used discrete sub-layers was inconsequential due to the thinness of the modeled sub-layers. The modeled structure is shown in Table 4.

TABLE 4
proposed model for a chromium oxide
contrast enhancing matrix layer.

| Layer | k @ 500 nm | n @ 500 nm | Thickness |
|---|---|---|---|
| Substrate | 0 | 1.6 | thick |
| Sub-Layer 1 | 0.001 | 1.787 | 10 nm |
| Sub-Layer 2 | 0.100 | 2.273 | 10 nm |
| Sub-Layer 3 | 0.200 | 2.573 | 10 nm |
| Sub-Layer 4 | 0.300 | 2.586 | 10 nm |
| Sub-Layer 5 | 0.400 | 2.598 | 10 nm |
| Sub-Layer 6 | 0.500 | 2.611 | 10 nm |
| Sub-Layer 7 | 0.600 | 2.623 | 10 nm |
| Sub-Layer 8 | 0.700 | 2.636 | 10 nm |
| Sub-Layer 9 | 0.800 | 2.648 | 10 nm |
| Sub-Layer 10 | 0.900 | 2.687 | 10 nm |
| Sub-Layer 11 | 1.000 | 2.747 | 10 nm |
| Sub-Layer 12 | 1.100 | 2.806 | 10 nm |
| Sub-Layer 13 | 1.200 | 2.866 | 10 nm |
| Sub-Layer 14 | 1.300 | 2.926 | 10 nm |
| Sub-Layer 15 | 1.400 | 2.986 | 10 nm |
| Sub-Layer 16 | 1.500 | 3.046 | 10 nm |
| Sub-Layer 17 | 1.600 | 3.070 | 10 nm |
| Sub-Layer 18 | 1.700 | 3.054 | 10 nm |
| Sub-Layer 19 | 1.800 | 3.038 | 10 nm |
| Sub-Layer 20 | 1.900 | 3.022 | 10 nm |
| Sub-Layer 21 | 2.000 | 3.005 | 10 nm |
| Sub-Layer 22 | 2.611 | 4.456 | 100 nm |

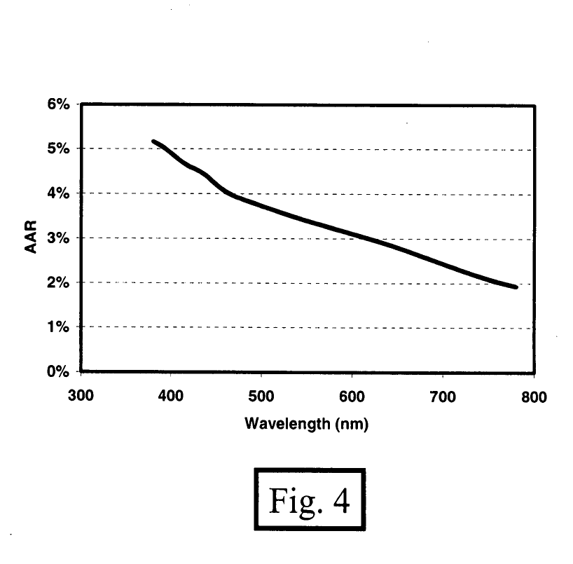

The graded absorber (contrast enhancing matrix layer) is approximated as 21 sub-layers of uniform composition in order to be compatible with the optical software. It has been found that dividing the graded absorber (contrast enhancing matrix layer) into finer sub-layers does not alter the modeled result significantly. Although index data is shown only for 500 nm in Table 4, the full data set from 380 nm to 780 nm was used for the model. The reflectivity of the contrast enhancing matrix layer, here, a black matrix layer, structure in Table 4 was computed at 21 sub-critical incident angles from 0 to 40 degrees (within the substrate material), and for 101 wavelengths from 380 to 780 nm. The angular data was integrated and averaged over solid angle to give AAR, and plotted as a function of wavelength in FIG. 4. The total thickness of this structure is 310 nm.

FIG. 4 shows that AAR varies with wavelength from 5% in the blue to 2% in the red. At 500 nm, the AAR is 3.7%. The RAI is 0.4 at 500 nm, which according to the current art should be acceptable. Yet, the performance is worse than predicted. The problem is that even though the k values are acceptable in this structure, the n values in the first 4 layers undergo a very large change, as can be seen at the top of Table 4. One can calculate the RIG for a portion of a layer. Considering the layer portion from the middle of sublayer 1 to the middle of sublayer 2, Δn=0.486, Δk=0.099, ΔT=10 nm, and λ=500 nm. The definition of RIG above gives a value of 24.8. This is very near the nominal recommended value which indicates a AAR in the vicinity of 5%.

### EXAMPLE 3b

### Low RIG Graded Contrast Enhancing Layer Made up of Multiple Sub-Layers

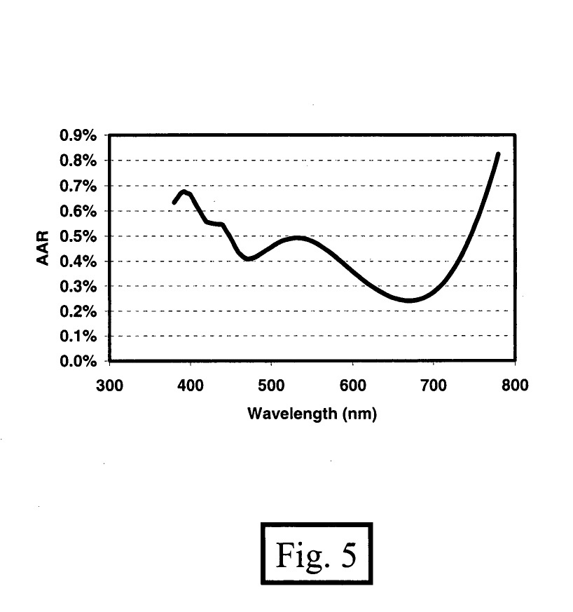

An improved contrast enhancing matrix layer, here, a black matrix layer, is obtained if the graded absorber (contrast enhancing matrix layer) is more gradual in the vicinity of the substrate. In the context of the model, this is accomplished by increasing the thickness of sub-layers 1 and 2 in Table 4 from 10 to 40 nm. To avoid an artifact of using stepped layers to approximate the graded absorber (contrast enhancing matrix layer), each of the 3 sub-layers in Table 4 was replaced by 4 sub-sub-layers of interpolated index. The improved contrast enhancing matrix layer, here, a black matrix layer, has an RIG of only 6 for the same region in the graded absorber (contrast enhancing matrix layer), but at the cost of an additional 60 nm of material. The AAR is shown graphically in FIG. 5. At all wavelengths, the AAR is now less than 1%. The total sputtered thickness of this structure is 370 nm.

It should be pointed out that the metallic chromium layer (sub-layer 22) does not play a major role in the AAR of the contrast enhancing matrix layer, here, a black matrix layer. Averaging the AAR over wavelength to give an overall performance metric, the structure of Example 2 has a full spectrum AAR of 0.5%. Removing the chromium layer actually reduces the full spectrum AAR to 0.45%, but it allows 0.3% of the light to be transmitted. Inclusion of the 100 nm thick chromium layer reduces transmitted light to 0.0001%. The value of including the opaque absorber is a function of the graded absorber (contrast enhancing matrix layer) design, and of the tolerance of the contrast enhancing matrix layer, here, a black matrix layer, application to transmitted light.

### EXAMPLE 4

### Graded Contrast Enhancing Layer Made up of Multiple Sub-Layers

Based on the learning of computed example 3A, a real contrast enhancing matrix layer was fabricated in the same vacuum coater used in Example 1. The oxygen flow was gradually reduced as the layer was coated. The coating was made such that 160 nm of thickness was coated as the oxygen flow was reduced from 2.1 sccm to 1.5 sccm; 160 nm was coated as the oxygen flow was reduced from 1.5 sccm to 0.6 sccm; 80 nm was coated as the oxygen flow was reduced from 0.6 sccm to 0.0 sccm, and 50 nm was coated with 0.0 sccm of oxygen flowing. This coating was made onto borosilicate glass. The coating appeared black, and when reflecting a collimated light beam, the reflection from the coating appeared to be an order of magnitude less than the reflection off the front of the glass (about 5.5% at 40 degrees).

### EXAMPLE 6

### Coverage of the Contrast Enhancing Matrix Layer

In this example the cell structure is very similar to that shown in FIG. 7. Three aperture values are used in the optical simulation, 0.86, 0.76, and 0.60, corresponding to black matrix coverage shown in FIG. 8, FIG. 9 and FIG. 10. The reflection layer 780 is a near Lambertian surface with a total reflection of 95%. The cell wall thickness is 10 μm, and the cell wall is set to translucent (T=0.82 at 10 μm). The depth of the dielectric fluid 720 is 10 μm, and this layer has a 100% transmittance for light in the visible spectrum (380 nm-780 nm) in the cell white state. In the black state the transmittance of this layer is reduced to 20%. The thickness of the upper insulating layer 730 is set to zero, and the thickness of the top substrate 710 is set to 700 μm. The pixel size is 500 μm×500 μm. In the simulation setup, the illumination comes from a Lambertian surface light source located above the cell. The receiver is located on the top surface of the top substrate 710. The recorded data is the intensity of light reflected by the cell at various viewing angles. Reflectance factor is defined as the ratio of the flux reflected from the specimen to the flux reflected from the perfect reflecting diffuser under the same geometric and spectral conditions of measurement (ASTM E 284 Standard Terminology of Appearance, 1988). For a reflecting material with near uniform response across the visible spectrum, the reflectance factor is highly correlated with luminance factor, which is defined as the ratio of the luminance of the surface to that of a perfect Lambertian surface. The electrophoretic example described here is a black and white monochromatic display, and hence the reflectance factor and luminance factor are highly correlated.

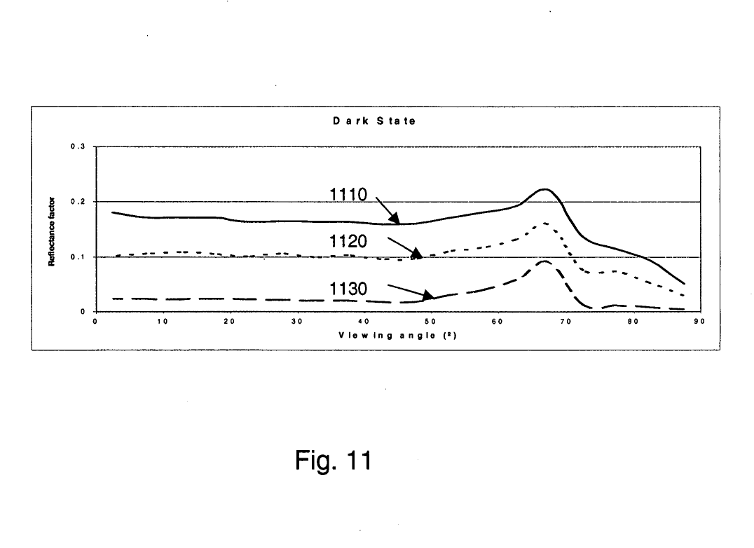

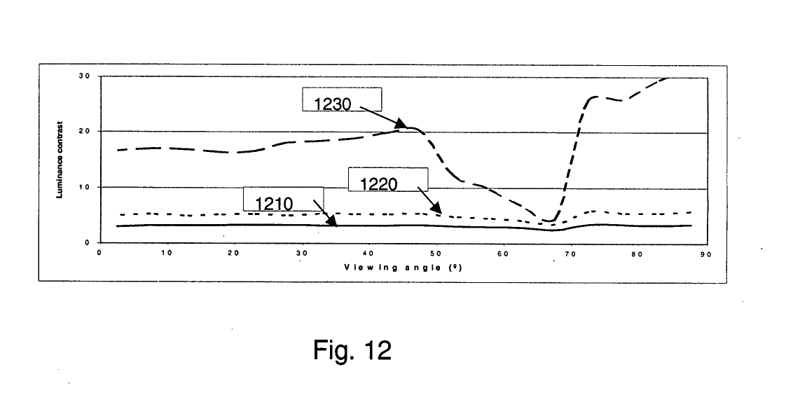

FIG. 11 shows the results of optical simulation using a non-sequential ray tracing software applications LIGHTTOOLS™ computer software. FIG. 11 shows the black state reflectance factor as a function of the viewing angle from the top of the electrophoretic cell array 600. The three curves 1110, 1120, and 1130 in FIG. 11 represent the reflectance factor for the aperture value of 0.86, 0.76, and 0.60. It can be seen from the chart that the black state luminance level is greatly reduced with the decrease in aperture value. This decrease in black state luminance level results in an increase in the luminance contrast, as can be seen in FIG. 12. FIG. 12 shows the luminance contrast level as a function of the viewing angle for three graded contrast enhancing matrix layer, here, black matrix layer options. Curve 1230 shows that the luminance contrast level is high (>15:1) across a large range of viewing angle if the entire inactive area is covered by the black graded contrast enhancing matrix layer. On the other hand, if the coverage only extends partially to the wall and the collecting electrode, the luminance contrast is not great (˜5:1, curve 1220). In the configuration given by a prior art, i.e., only the cell partition walls are covered, the luminance contrast is further reduced to 3:1 or less (curve 1210).

Luminance contrast is closely related to image/text quality. In the domain of informational display, text quality is considered most relevant. In literature numerous research efforts have been documented regarding the minimum luminance contrast requirement for text legibility and readability. The current consensus is that a luminance contrast of 3:1 is the minimum for text legibility (Spenkelink and Besuijen, 1994). A higher luminance contrast is in general linked to a higher performance in text reading. From the luminance contrast point of view the option depicted in the prior art (curve 1210 in FIG. 12) is insufficient in rending a good-quality informational display. The best option would be to cover the entire area, as shown in curve 1230. It should also be noted that white state luminance level is also an important index of image quality for a display device. When determining the appropriate level of aperture both the white state luminance level and the luminance contrast need to be taken into consideration.

Research on color naming and identification indicates that observers would typically consider achromatic stimuli with OSA L values from −4 to 0 as gray and those greater than 3 as white (R. M. Boynton, C. X. Olson, “Locating Basic Colors in the OSA Space”, Color Res. App. 12, pp. 94-105 (1987). For stimuli that are essentially non-selective (low in chroma), these correspond to reflectivity ranges of 11% to 30% for gray, and greater than 52% for white (see N. Moroney, “A Radial Sampling of the OSA Uniform Color Scales”, IS&T/SID Eleventh Color Imaging Conference, Nov. 3, 2003, pp>175-180. for conversion information). Hence, it is preferable to create a light state that has greater than 30% reflectivity, and even more preferred to be equal to or greater than 52%. Black is less than 7% reflectivity by analogous arguments.

A mask will be considered black if it reflects less than 7% of the incident light.

Optically modeling (race tracing) studies reveal that the integrated reflectivity of such a configuration will never exceed the aperture value, i.e. that the assembly with 30% aperture will have a light state limitation of 30%. In practice, due to reflectors with less than perfect reflectivity, and illumination conditions that are more diffuse than specular in nature, the bright state will be much less that this. Given that opaque black masks may have reflectivities as high as 7%, it is possible to achieve bright states that may be considered “not gray” with apertures of at least 25%. Analogously, it is possible to achieve bright states that might be considered white by some observers with apertures of at least 48%. Thus, apertures of greater about 48% are preferred.

Consider a reflective surface of unit area, an illuminant and an intervening absorptive layer situated between the first two elements, which has a variable size opening. The aperture of this absorptive layer is defined as the ratio of the opening area to the reflective surface area, expressed as a percentage. If the absorptive layer is continuous with no opening, the aperture is zero. Analogously, as the area of the layer becomes infinitesimally small, the aperture approaches 100.

Given that reflectivities of approximately 52% and higher may be perceived as white by some observers, we consider reflectivities of 52% and higher to be high reflectivity. Given that reflectivities of less that 7% may be considered back by some observers, we consider transmittances less than 7% to be low (something that would be 100% transmittance placed in front of a source would be your “white”).

### EXAMPLE 7

### Positioning of the Contrast Enhancing Matrix Layer

The positioning of the contrast enhancing matrix layer refers to the displacement 910 of the contrast enhancing matrix layer 810 from the reflecting layer 740, as shown in FIG. 9. The designed distance of the two may vary during the manufacturing of the device. A robust design of the display needs to reduce the variation in luminance when the distance between the two surfaces varies.

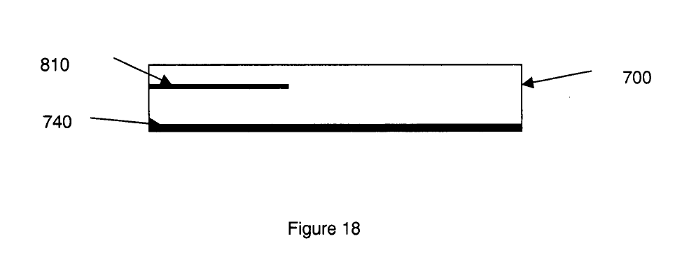

A study was conducted using optical modeling tools on the displacement of the contrast enhancing black matrix 810 from the reflecting layer 740 as shown in FIG. 9. The cell design is a simplified electrophoretic cell structure, as shown in FIG. 18. The pixel size is 500 μm×500 μm. The total cell height is 100 μm. The aperture of the black matrix is fixed at 0.67. The whole cell used a single material with a refractive index of 1.60 and a transmittance of 100%. The black matrix top surface reflects 1%, and absorbs the remaining 99% of incident light. The bottom surface reflectance is a control variable. The reflecting surface has is a perfect Lambertian surface. The light source is a Lambertian surface light located on top of the cell. The reported data is the total % reflectance, measured as the ratio of the reflected light from the cell collected over the entire hemisphere to that from a perfect Lambertian surface.

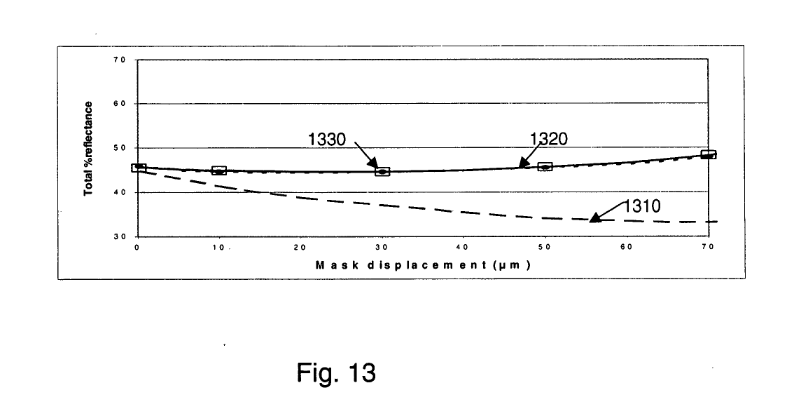

FIG. 13 shows the optical modeling simulation results of the study. The vertical axis shows the total percent reflectance measured in the viewing-side hemisphere. Curve 1310 shows the condition when the bottom reflectance is set comparable to the top reflectance, i.e. 1%. Given this condition, the white state reflectance factor of the cell decreases significantly with the increase in the distance. Curve 1320 shows a condition when the reflectance of the bottom surface of the black graded contrast enhancing matrix layer 810 is set high (>90%) and is specular. Given this condition, the white state reflectance stays unchanged with the displacement of the contrast enhancing black matrix 810 from the reflecting layer 740. Curve 1330 shows the simulation results when the reflectance of the bottom surface of the black contrast enhancing matrix layer is set to be high (>90%) and diffuse. Again, the white state reflectance stays unchanged with the change in displacement of the contrast enhancing black matrix 810 from the reflecting layer 740. In conclusion, the robustness of the graded contrast enhancing matrix layer, here, a black matrix layer, can be achieved when the reflectance of the bottom surface of the contrast enhancing matrix layer is high.

The invention has been described in detail with particular reference to certain preferred embodiments thereof, but it will be understood that variations and modifications can be effected within the spirit and scope of the invention.

### PARTS LIST

100 contrast enhancing film
102 incident light ray
104 refracted light ray
106 antireflection layer
108 transparent substrate
110 graded absorber (contrast enhancing matrix layer)
112 opaque layer
114 transparent side of the graded absorber (contrast enhancing matrix layer)
116 opaque side of the graded absorber (contrast enhancing matrix layer)
600 electrophoretic display 3×3 cell array
610 active area
620 inactive area
640 graded contrast enhancing matrix OK to here, Parts for FIGS. 7-13, 17
700 in-plane-switching electrophoretic cell from prior art
710 top substrate layer
720 transparent dielectric fluid layer
730 upper insulating layer
740 middle insulating and reflection layer
744 black particles
746 gap between driving electrode 780 and black particles 744
750 bottom substrate layer
760 cell wall
770 driving electrodes
780 driving electrode
790 light ray
796 light ray
810 black matrix
820 distance between black matrix 810 and reflecting layer 740
1110 curve showing reflectance factor as a function of viewing angle for an aperture value of 0.86
1120 curve showing reflectance factor as a function of viewing angle for an aperture value of 0.76
1130 curve showing reflectance factor as a function of viewing angle for an aperture value of 0.60
1210 curve showing luminance contrast as a function of viewing angle for an aperture value of 0.86
1220 curve showing luminance contrast as a function of viewing angle for an aperture value of 0.76
1230 curve showing luminance contrast as a function of viewing angle for an aperture value of 0.60
1310 curve showing total percent reflectance as a function of distance 820 when the bottom reflectance is low (<1%)
1320 curve showing total percent reflectance as a function of distance 820 when the bottom reflectance is high (>90%) and is specular
1330 curve showing total percent reflectance as a function of distance 820 when the bottom reflectance is high (>90%) and is diffuse
1400 Substrate for black mask
1401 Cr/CrOₓ stack or gradient
1402 Photoresist
1510 curve showing the total reflectance of the coated sample used in Example 1
1520 curve showing the diffuse reflectance of the coated sample used in Example 1
1700 stacked color display unit
1701 transparent display unit (closest to viewer)
1703 transparent display unit (2^{nd} in stack)
1705 adhesive layer
1707 reflective display unit
1708 bottom transparent substrate
1709 white reflector substrate
1710 contrast enhancing layer
1711 electroptic fluid
1750 top transparent substrate
1760 cell partition wall
1770 patterned electrodes

1. A display comprising a substrate, an inactive area comprising at least one conductive layer, and an active area comprising an electrically modulated imaging layer comprising an electrically modulated imaging material, and at least one graded contrast enhancing matrix layer, wherein said graded contrast enhancing matrix layer comprises a light absorbing material, wherein said graded contrast enhancing matrix layer has a refractive index, wherein the imaginary part of said refractive index increases with distance from said substrate, and the change in said imaginary part of said refractive index through the thickness of said graded contrast enhancing matrix layer is greater than 0.2, wherein said graded contrast enhancing matrix layer registers with at least a portion of said inactive area and extends into said active area.

2. The display of claim 1 wherein said graded contrast enhancing matrix layer is black.

3. The display of claim 1 wherein said at least one graded contrast enhancing matrix layer is a single graded layer.

4. The display of claim 1 wherein said at least one graded contrast enhancing matrix layer comprises at least two sub-layers.

5. The display of claim 1 wherein said at least one graded contrast enhancing matrix layer has an Angle Averaged Reflectivity (AAR) of less than 5%.

6. The display of claim 1 wherein said graded contrast enhancing matrix layer has a transparent side adjacent said support with an Interfacial Index Discontinuity (IID) with said substrate of less than 0.60.

7. The display of claim 1 wherein the reduced absorption integral (RAI) of said graded contrast enhancing matrix layer is greater than 0.05.

8. The display of claim 1 wherein the reduced index gradient (RIG) of said graded contrast enhancing matrix layer or any part thereof is less than 25.

9. The display of claim 1 wherein said graded contrast enhancing matrix layer has a transparent side adjacent said support with an Interfacial Index Discontinuity (IID) with said substrate of less than 0.60, the reduced absorption integral (RAI) of said graded contrast enhancing matrix layer is greater than 0.05, the reduced index gradient (RIG) of said graded contrast enhancing matrix layer or any part thereof is less than 25, and said at least one graded contrast enhancing matrix layer has an Angle Averaged Reflectivity (AAR) of less than 5.0%.

10. The display of claim 1 wherein said graded contrast enhancing matrix layer has a transparent side adjacent said support with an Interfacial Index Discontinuity (IID) with said substrate of less than 0.25, the reduced absorption integral (RAI) of said graded contrast enhancing matrix layer is greater than 0.50, the reduced index gradient (RIG) of said graded contrast enhancing matrix layer or any part thereof is less than 5, and said at least one graded contrast enhancing matrix layer has an Angle Averaged Reflectivity (AAR) of less than 0.5%.

11. The display of claim 1 wherein the area of said active area into which said graded contrast enhancing-matrix layer does not extend comprises 25%.

12. The display of claim 1 wherein said graded contrast enhancing matrix layer at the point farthest from said substrate provides an Angle Averaged Reflectivity (AAR) in excess of 40% at all wavelengths generated by said display and a wavelength averaged value (AAR) in excess of 60%.

13. The display of claim 1 wherein the absorption of said graded contrast enhancing matrix layer is tuned with respect to the illuminant to minimize heating.

14. The display of claim 1 wherein said at least one graded contrast enhancing matrix layer has an optical density greater than 0.5.

15. The display of claim 1 wherein said at least one graded contrast enhancing matrix layer is patterned.

16. The display of claim 1 wherein said light absorbing material is an oxide of chromium

17. The display of claim 1 wherein said light absorbing material is a metal/metal oxide, metal/metal sulfide, metal/metal nitride, or mixture thereof of a metal selected from the group consisting of silver, silicon, titanium, tantalum, and chromium.

18. The display of claim 17 wherein said metal comprises at least one member selected from the group consisting of Ag, Al, Mg, Pt, Pd, Ir, Ni, Ta, Sn, Sb, In, Ti, Cu and Au.

19. The display of claim 1 wherein said light absorbing materials absorbs wavelengths of from 380 to 780 nm.

20. The display of claim 1 wherein said at least one graded contrast enhancing matrix layer has a thickness of 100 nm to 1000 nm.

21. The display of claim 1 wherein said graded contrast enhancing matrix layer is flexible.

22. The display of claim 1 wherein said graded contrast enhancing matrix layer has a low reflectance AAR of less than about 5% and has a transmittance of less than about 7%.

23. The display of claim 1 wherein said imaginary part of said refractive index increases monotonically.

24. The display of claim 1 wherein said substrate is flexible.

25. The display of claim 1 wherein said substrate is nonconductive.

26. The display of claim 1 wherein said display is a reflective display.

27. The display of claim 1 wherein said electrically modulated imaging layer is an electrophoretic imaging layer.

28. The display of claim 1 wherein said electrically modulated imaging layer is an electrowetting imaging layer.

29. The display of claim 1 wherein said electrically modulated imaging layer is an electrochromic imaging layer.

30. The display of claim 1 wherein said display has a luminance contrast greater than 5:1.

31. The display of claim 1 wherein said at least one conductive layer comprises two conductive layers, wherein said two conductive layers are placed opposing each other and having said active area comprising an electrically modulated imaging layer comprising an electrically modulated imaging material therebetween.

32. The display of claim 1 wherein said at least one conductive layer comprises two conductive layers, wherein said two conductive layers are placed on the same side of said active area comprising an electrically modulated imaging layer comprising an electrically modulated imaging material.

33. The display of claim 1 further comprising partition walls separating said active area into active cell areas, wherein said partition walls are part of said inactive area.

34. The display of claim 1 further comprising an opaque layer on the side of said graded contrast enhancing matrix layer opposite said substrate.

35. The display of claim 34 wherein said opaque layer is a metal.

36. The display of claim 35 wherein said wherein said metal is at least one member selected from the groups consisting of Ag, Al, Mg, Pt, Pd, Ir, Ni, Ta, Sn, Sb, In, Ti, Cu and Au.

37. The display in claim 35 in which said metal comprises a non-oxidized form of the metal used in said graded contrast enhancing matrix layer.

38. A display comprising, in order, a transparent substrate, a graded contrast enhancing matrix layer matched to the index of refraction of said transparent substrate and becoming gradually more absorbing as one proceeds within said graded contrast enhancing matrix layer away from said transparent substrate, a transparent dielectric fluid layer comprising a dielectric fluid divided into cells by a plurality of spacers, wherein said spacers maintain a gap for containing said dielectric fluid between said transparent substrate and an upper insulating layer, a middle insulating and reflection layer, and a bottom substrate layer, wherein said graded contrast enhancing matrix layer comprises a light absorbing material, wherein said graded contrast enhancing matrix layer has a refractive index, wherein the imaginary part of said refractive index increases with distance from said substrate, and the change in said imaginary part of said refractive index through the thickness of said graded contrast enhancing matrix layer is greater than 0.2, wherein said graded contrast enhancing matrix layer is between said transparent substrate and said transparent dielectric fluid layer, registers with at least a portion of said spacers and extends into at least a portion of said dielectric fluid.

39. The display of claim 38 wherein said graded contrast enhancing matrix layer is black.

40. A method of making a display comprising:
a. providing a substrate;
b. applying at least one patterned, graded contrast enhancing matrix layer thereon, wherein said graded contrast enhancing matrix layer comprises a light absorbing material, wherein said graded contrast enhancing matrix layer has a refractive index, wherein the imaginary part of said refractive index increases with distance from said substrate, and the change in said imaginary part of said refractive index through the thickness of said graded contrast enhancing matrix layer is greater than 0.2, wherein said graded contrast enhancing matrix layer registers with at least a portion of the inactive area of said display and extends into the active area of said display;
c. applying an inactive area comprising at least one conductive layer; and
d. applying an active area comprising an electrically modulated imaging layer comprising an electrically modulated imaging material.

41. The method of claim 40 wherein said graded contrast enhancing matrix layer is fully oxidized metal at the side of said graded contrast enhancing matrix layer adjacent said transparent substrate, and gradually decrease in level of oxidation until there is little oxidant at the side of said graded contrast enhancing matrix layer opposite said transparent substrate.

42. The method of claim 40 wherein said graded contrast enhancing matrix layer is a single vacuum sputtered layer prepared by providing a metal target; sputtering said target with a sputtering mixture comprising a metal and gas combination of oxidant plus Argon gas; gradually decreasing said oxidant in said sputtering mixture until said mixture is fully metallic.

43. The method of claim 42 wherein said metal is chromium and said oxidant is oxygen.
